(19) United States
(12) Patent Application Publication
(10) Pub. No.: US 2006/0263689 A1
(43) Pub. Date: Nov. 23, 2006

(54) ANODE ACTIVE MATERIAL AND BATTERY

(76) Inventors: Hidetaka Ishihara, Fukushima (JP); Hiroshi Horiuchi, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/383,778

(22) Filed: May 17, 2006

(30) Foreign Application Priority Data
May 19, 2005 (JP) P2005-147074
Oct. 7, 2005 (JP) P2005-295359
Jan. 23, 2006 (JP) P2006-13911

(51) Int. Cl. H01M 4/58; C22C 13/00; H01B 1/02

(52) U.S. Cl. 429/221; 429/231.8; 429/219; 429/231.5; 252/182.1; 420/557; 252/503

(57) ABSTRACT

An anode active material with a high capacity capable of providing superior cycle characteristics and a battery using it are provided. An anode contains an anode active material capable of reacting with lithium. The anode active material contains at least tin, iron, and carbon as an element. The carbon content is from 11.9 wt % to 29.7 wt %, and the iron ratio to the total of tin and iron is from 26.4 wt % to 48.5 wt %. Thereby, while a high capacity is maintained, the cycle characteristics are improved.

### CROSS REFERENCES TO RELATED APPLICATIONS

The present invention contains subject matter related to Japanese Patent Application JP 2005-147074 filed in the Japanese Patent Office on May 19, 2005, Japanese Patent Application JP 2005-295359 filed in the Japanese Patent Office on Oct. 7, 2005, and Japanese Patent Application JP 2006-13911 filed in the Japanese Patent Office on Jan. 23, 2006, the entire contents all of which are incorporated herein by references.

### BACKGROUND OF THE INVENTION

1. Field of the Invention

The present invention relates to an anode active material containing tin (Sn), iron (Fe), and carbon (C) as an element and a battery using the anode active material.

2. Description of the Related Art

In recent years, many portable electronic devices such as a combination camera (Videotape Recorder), a mobile phone, and a notebook personal computer have been introduced, and downsizing and weight saving of such devices have been made. Research and development for improving the energy density of the battery used as a portable power source for such electronic devices, in particular the secondary battery as a key device has been actively promoted. Specially, a nonaqueous electrolyte secondary battery (for example, lithium ion secondary battery) provides a higher energy density compared to a lead battery or a nickel cadmium battery, which is a traditional aqueous electrolytic solution secondary battery. Therefore, improvement thereof has been considered in respective fields.

As an anode active material used for the lithium ion secondary battery, carbon materials such as non-graphitizable carbon and graphite, which show a relatively high capacity and favorable cycle characteristics, have been widely used. However, taking account of the demand for high capacity in these days, it is a task to obtain a higher capacity of the carbon material.

From such a background, a technique for attaining a high capacity with a carbon material by selecting a carbonized raw material and preparation conditions has been developed (for example, refer to Japanese Unexamined Patent Application Publication No. H08-315825). However, in the case that such a carbon material is used, the anode discharge potential to lithium (Li) is from 0.8 V to 1.0 V, and the battery discharging voltage when forming the battery becomes low, and therefore significant improvement is not expected in view of the battery energy density. Further, there are disadvantages that hysteresis is large in the shape of charge and discharge curve, and energy efficiency in each charge and discharge cycle is low.

Meanwhile, as a high capacity anode exceeding the carbon materials, researches on alloy materials applying the fact that certain metals are electrochemically alloyed with lithium, and the alloy is reversibly generated and decomposed have been also promoted. For example, a high capacity anode using Li-Al alloy or Sn alloy has been developed, and further a high capacity anode made of Si alloy has been developed (for example, refer to U.S. Pat. No. 4,950,566).

However, there is a large disadvantage that Li—Al alloy, Sn alloy, or Si alloy is expanded and shrunk by charge and discharge, and the anode is pulverized every charge and discharge, and therefore the cycle characteristics are very poor.

Therefore, as a method to improve cycle characteristics, it has been considered to inhibit such expansion by alloying tin or silicon (Si). For example, it has been suggested that a transition metal such as iron and tin are alloyed (for example, refer to Japanese Unexamined Patent Application Publication Nos. 2004-22306, 2004-63400, and 2005-78999, “Journal of The Electrochemical Society,” 1999, Vol. 146, p. 405, “Journal of The Electrochemical Society,” 1999, Vol. 146, p. 414, and “Journal of The Electrochemical Society,” 1999, Vol. 146, p. 423). Further, Mg₂Si or the like has been suggested (for example, refer to “Journal of The Electrochemical Society,” 1999, Vol. 146, p. 4401).

### SUMMARY OF THE INVENTION

However, even in the cases using the foregoing methods, it is actual condition that effects of improving cycle characteristics are not sufficient and advantages of the high capacity anode in the alloy material are not sufficiently utilized.

In view of the foregoing, in the present invention, it is desirable to provide an anode active material which has a high capacity and provides superior cycle characteristics and a battery using the anode active material.

According to an embodiment of the present invention, there is provided an anode active material, in which at least tin, iron, and carbon are contained as an element, the carbon content is from 11.9 wt % to 29.7 wt %, and the iron ratio to the total of tin and iron is from 26.4 wt % to 48.5 wt %.

According to an embodiment of the present invention, there is provided a battery including a cathode, an anode, and an electrolyte, in which the anode contains an anode active material containing at least tin, iron, and carbon as an element, the carbon content in the anode active material is from 11.9 wt % to 29.7 wt %, and the iron ratio to the total of tin and iron is from 26.4 wt % to 48.5 wt %.

According to the anode active material of the embodiment of the present invention, since tin is contained as an element, a high capacity can be obtained. Further, since iron is contained as an element and the iron ratio to the total of tin and iron is from 26.4 wt % to 48.5 wt %, while a high capacity is maintained, the cycle characteristics can be improved. Further, since carbon is contained as an element and the carbon content is from 11.9 wt % to 29.7 wt %, the cycle characteristics can be further improved. Therefore, according to the battery of the embodiment of the present invention using the anode active material, a high capacity can be obtained, and superior cycle characteristics can be obtained.

Further, when silver (Ag) is contained in the anode active material as an element, reactivity to the electrolyte can be decreased, and cycle characteristics can be more improved. In particular, when the silver content in the anode active material is from 0.1 wt % to 9.9 wt %, a higher capacity can be obtained.

Further, when silicon is contained in the anode active material as an element, a higher capacity can be obtained.

Furthermore, when at least one from the group consisting of aluminum (Al), titanium (Ti), vanadium (V), chromium (Cr), niobium (Nb), and tantalum (Ta), and at least one from the group consisting of cobalt (Co), nickel (Ni), copper (Cu), zinc (Zn), gallium (Ga), and indium (In) are contained in the anode active material as an element, the cycle characteristics can be more improved. In particular, when the contents thereof are from 0.1 wt % to 9.9 wt % and from 0.5 wt % to 14.9 wt %, respectively, a higher capacity can be obtained.

In addition, when a cyclic carbonate derivative having halogen atom is contained in the electrolyte, decomposition reaction of the solvent in the anode can be inhibited, and the cycle characteristics can be further improved. Further, when a cyclic sulfur compound is contained in addition to the cyclic carbonate derivative, decomposition reaction of the solvent can be more inhibited, and higher effect can be obtained.

Other and further objects, features and advantages of the invention will appear more fully from the following description.

### BRIEF DESCRIPTION OF THE DRAWINGS

FIG. 1 is a cross section showing a structure of a secondary battery according to an embodiment of the present invention;

FIG. 2 is a cross section showing an enlarged part of a spirally wound electrode body in the secondary battery shown in FIG. 1;

FIG. 3 is an exploded perspective view showing a structure of another secondary battery according to an embodiment of the present invention;

FIG. 4 is a cross section showing a structure taken along line I-I of a spirally wound electrode body shown in FIG. 3;

FIG. 5 is a cross section showing a structure of a coin type battery fabricated in examples;

FIG. 6 is a characteristics view showing a relation between the carbon content in the anode active material, and the capacity retention ratio and the initial charging capacity;

FIG. 7 is a characteristics view showing a relation between the iron ratio to the total of tin and iron in the anode active material, and the capacity retention ratio and the initial charging capacity;

FIG. 8 is another characteristics view showing a relation between the iron ratio to the total of tin and iron in the anode active material, and the capacity retention ratio and the initial charging capacity;

FIG. 9 is another characteristics view showing a relation between the iron ratio to the total of tin and iron in the anode active material, and the capacity retention ratio and the initial charging capacity;

FIG. 10 is another characteristics view showing a relation between the carbon content in the anode active material, and the capacity retention ratio and the initial charging capacity;

FIG. 11 is another characteristics view showing a relation between the iron ratio to the total of tin and iron in the anode active material, and the capacity retention ratio and the initial charging capacity;

FIG. 12 is another characteristics view showing a relation between the iron ratio to the total of tin and iron in the anode active material, and the capacity retention ratio and the initial charging capacity; and

FIG. 13 is another characteristics view showing a relation between the iron ratio to the total of tin and iron in the anode active material, and the capacity retention ratio and the initial charging capacity.

### DETAILED DESCRIPTION OF THE PREFERRED EMBODIMENT

An embodiment of the present invention will be hereinafter described in detail with reference to the drawings.

An anode active material according to an embodiment of the present invention is capable of reacting with lithium or the like, and contains tin and iron as an element. Tin has a high reaction amount of lithium per unit weight and provides a high capacity. Further, though it is difficult to provide sufficient cycle characteristics by the simple substance of tin, it is possible to improve cycle characteristics by containing iron.

For the iron content, it is preferable that the iron ratio to the total of tin and iron is in the range from 26.4 wt % to 48.5 wt %, and it is more preferable that the iron ratio to the total of tin and iron is in the range from 29.3 wt % to 45.5 wt %. When the ratio is low, the iron content is decreased and it is difficult to obtain sufficient cycle characteristics. Meanwhile, when the ratio is high, the tin content is decreased, and it is difficult to obtain advantage of tin capacity to the traditional anode material capacity such as the carbon material capacity.

The anode active material further contains carbon in addition to tin and iron as an element. By containing carbon, cycle characteristics can be further improved. The carbon content is preferably in the range from 11.9 wt % to 29.7 wt %, more preferably in the range from 13.9 wt % to 27.7 wt %, and in particular, much more preferably in the range from 15.8 wt % to 23.8 wt %. In such a range, high effects can be obtained.

In some cases, the anode active material preferably further contains silver as an element in addition to the foregoing elements. Thereby, reactivity to the electrolyte can be decreased, and the cycle characteristics can be improved. The silver content is preferably in the range from 0.1 wt % to 9.9 wt %, more preferably in the range from 1.0 wt % to 7.4 wt %, and in particular, desirably in the range from 2.0 wt % to 5.0 wt %. When the silver content is small, effects to improve cycle characteristics are not sufficient. Meanwhile, when the silver content is large, the tin content is lowered and it is difficult to obtain sufficient capacity.

In some cases, the anode active material preferably further contains silicon as an element in addition to the foregoing elements. Silicon has a high reaction amount of lithium per unit weight and further improves the capacity. The silicon content is preferably in the range from 0.5 wt % to 7.9 wt %. When the silicon content is small, effects to improve the capacity are not sufficient. Meanwhile, when the silicon content is large, cycle characteristics are lowered. Silicon can be contained together with silver.

In some cases, the anode active material preferably contains at least one from the group consisting of aluminum, titanium, vanadium, chromium, niobium, and tantalum, and at least one from the group consisting of cobalt, nickel, copper, zinc, gallium, and indium. Thereby, cycle characteristics can be further improved. The contents of aluminum, titanium, vanadium, chromium, niobium, and tantalum are preferably from 0.1 wt % to 9.9 wt %, and the contents of cobalt, nickel, copper, zinc, gallium, and indium are preferably from 0.5 wt % to 14.9 wt %. When the contents thereof are small, it is difficult to obtain sufficient effects. When the contents thereof are large, the tin content is decreased, and it is difficult to obtain sufficient capacity. These elements can be contained together with silver or silicon.

The anode active material has a phase with low crystallinity or an amorphous phase. Such a phase is a reactive phase capable of reacting with lithium or the like. Thereby, superior cycle characteristics can be obtained. For a half value width of the diffraction peak obtained by X-ray diffraction of the phase, diffraction angle 20 is preferably 0.5 deg or more where CuKα-ray is used as specific X-ray and the sweep rate is 1 deg/min. Thereby, lithium or the like can be more smoothly inserted and extracted, and reactivity to the electrolyte can be more decreased.

Whether the diffraction peak obtained by X-ray diffraction corresponds to the reactive phase capable of reacting with lithium or the like or not can be easily determined by comparing X-ray diffraction charts before and after electrochemical reaction with lithium or the like. For example, when the diffraction peak position is changed before and after electrochemical reaction with lithium or the like, such diffraction peak corresponds to the reactive phase capable of reacting with lithium or the like. In the anode active material, the diffraction peak of the reactive phase with low crystallinity or the amorphous reactive phase is observed, for example, in the range of 20=from 20 deg to 50 deg. The reactive phase with low crystallinity or the amorphous reactive phase contains, for example, the foregoing respective elements. It is thinkable that the reactive phase with low crystallinity or the amorphous reactive phase is mainly obtained by carbon.

In some cases, the anode active material contains a phase containing simple substances of the respective elements or part thereof in addition to the phase with low crystallinity or the amorphous phase.

As a measuring method for examining bonding state of elements, for example, X-ray Photoelectron Spectroscopy (XPS) can be cited. XPS is a method for examining element composition and element bonding state in the region several nm from the sample surface by irradiating the sample surface with soft X-ray (using Al—K α-ray or Mg—K α-ray in commercially available equipment) and measuring kinetic energy of photoelectron jumping out from the sample surface.

The bound energy of the inner orbital electron of elements is changed related to the charge density on the elements in view of first proximity. For example, when the charge density of carbon element is decreased by interaction with elements existing in the vicinity thereof, outer-shell electron such as 2p electron is decreased. Therefore, Is electron of carbon element is strongly bound by the shell. That is, when the charge density of the element is decreased, the bound energy is increased. In XPS, when the bound energy is increased, the peak is shifted to the high energy region.

In XPS, in the case of graphite, the peak of 1 s orbit of carbon (C1s) is observed at 284.5 eV in the apparatus in which energy calibration is made so that the peak of 4f orbit of gold atom (Au4f) is observed at 84.0 eV. In the case of surface contamination carbon, the peak is observed at 284.8 eV. Meanwhile, in the case of higher charge density of carbon element, for example, when carbon is to a metal element or a metalloid element, the peak of C1s is observed in the region lower than 284.5 eV. That is, when the peak of the composite wave of C1s obtained for the anode active material is observed in the region lower than 284.5 eV, at least part of carbon contained in the anode active material is bonded to the metal element or the metalloid element, which is other element.

In XPS measurement of the anode active material, when the surface is coated with the surface contamination carbon, the surface is preferably lightly sputtered by the argon ion gun provided on XPS equipment. Further, when the anode active material which is subject for measurement exists in the anode of the battery as described later, after the battery is disassembled to take out the anode, the anode shall be washed with a volatile solvent such as dimethyl carbonate in order to remove the solvent with low volatility and an electrolyte salt, which exist on the surface of the anode. Such sampling is desirably performed under the inert atmosphere.

In XPS measurement, for example, the peak of C1s is used for correcting the energy axis of spectrums. Since surface contamination carbon generally exists on the substance surface, the peak of C1s of the surface contamination carbon is set to at 284.8 eV, which is used as an energy reference. In XPS measurement, the waveform of the peak of C1s is obtained as a form including the peak of the surface contamination carbon and the peak of carbon in the anode active material. Therefore, for example, by analyzing the waveform by using commercially available software, the peak of the surface contamination carbon and the peak of carbon in the anode active material are separated. In the analysis of the waveform, the position of the main peak existing on the lowest bound energy side is set to the energy reference (284.8 eV).

The anode active material can be formed by, for example, mixing raw materials of each element, which is dissolved in an electric furnace, a high frequency induction furnace, an arc melting furnace or the like and then solidified. Otherwise, the anode active material can be formed by various atomization methods such as gas atomizing and water atomizing; various roll methods; or a method utilizing mechanochemical reaction such as mechanical alloying method and mechanical milling method. Specially, the anode active material is preferably formed by the method utilizing mechanochemical reaction since the anode active material thereby becomes a low crystal structure or an amorphous structure. For such a method, for example, a planetary ball mill device can be used.

For a raw material, simple substances of the respective elements can be used by mixing. However, for part of elements other than carbon, alloys are preferably used. By synthesizing the anode active material with a method utilizing mechanochemical reaction by adding carbon to such an alloy, the anode active material can have a low crystal structure or an amorphous structure, and the reaction time can be reduced. The form of the raw material may be powder or a mass.

For carbon used as a raw material, one or more carbon materials such as non-graphitizable carbon, graphitizable carbon, graphite, pyrolytic carbons, cokes, glassy carbons, organic high molecular weight compound fired body, activated carbon, and carbon black can be used. Of the foregoing, cokes include pitch cokes, needle cokes, petroleum cokes and the like. The organic high molecular weight compound fired body is a substance obtained by firing and carbonizing a high molecular weight compound such as a phenol resin and a furan resin at an appropriate temperature. The shape of the carbon materials may be any of fibrous, spherical, granulated, and scale-like.

The anode active material is used for a secondary battery as follows, for example.

(First Secondary Battery)

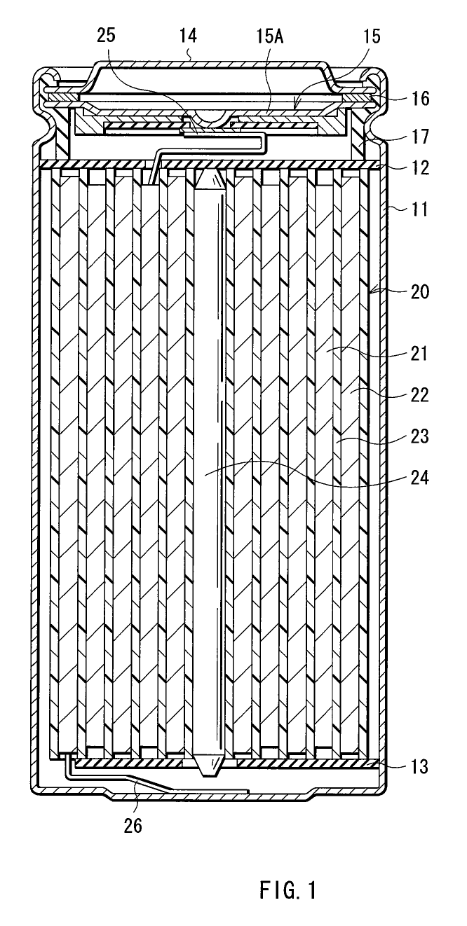

FIG. 1 shows a cross sectional structure of a first secondary battery. The secondary battery is a so-called cylinder-type battery, and has a spirally wound electrode body 20 in which a strip-shaped cathode 21 and a strip-shaped anode 22 are layered and wound with a separator 23 in between inside a battery can 11 in the shape of approximately hollow cylinder. The battery can 11 is made of, for example, iron plated by nickel. One end of the battery can 11 is closed, and the other end thereof is opened. Inside the battery can 11, an electrolytic solution as a liquid electrolyte is injected and impregnated in the separator 23. Further, a pair of insulating plates 12 and 13 is respectively arranged perpendicular to the winding periphery face, so that the spirally wound electrode body 20 is sandwiched between the insulating plates 12 and 13.

At the open end of the battery can 11, a battery cover 14, and a safety valve mechanism 15 and a PTC (Positive Temperature Coefficient) device 16 provided inside the battery cover 14 are attached by being caulked with a gasket 17. Inside of the battery can 11 is hermetically closed. The battery cover 14 is, for example, made of a material similar to that of the battery can 11. The safety valve mechanism 15 is electrically connected to the battery cover 14 through the PTC device 16. When the internal pressure of the battery becomes a certain level or more by internal short circuit, external heating or the like, a disk plate 15A flips to cut the electrical connection between the battery cover 14 and the spirally wound electrode body 20. When temperatures rise, the PTC device 16 limits a current by increasing the resistance value to prevent abnormal heat generation by a large current. The gasket 17 is made of, for example, an insulating material and its surface is coated with asphalt.

For example, a center pin 24 is inserted in the center of the spirally wound electrode body 20. A cathode lead 25 made of aluminum or the like is connected to the cathode 21 of the spirally wound electrode body 20. An anode lead 26 made of nickel or the like is connected to the anode 22. The cathode lead 25 is electrically connected to the battery cover 14 by being welded to the safety valve mechanism 15. The anode lead 26 is welded and electrically connected to the battery can 11.

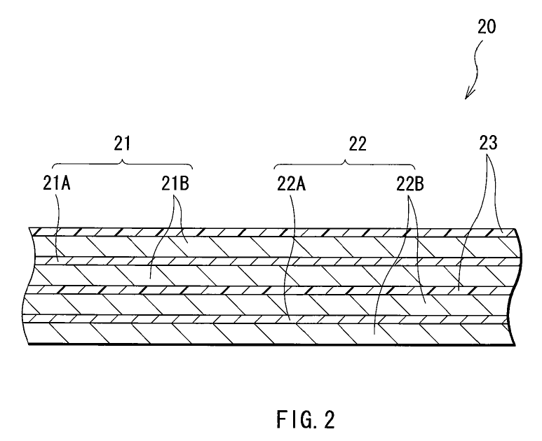

FIG. 2 shows an enlarged part of the spirally wound electrode body 20 shown in FIG. 1. The cathode 21 has a structure in which, for example, a cathode active material layer 21B is provided on the both faces or one face of a cathode current collector 21A having a pair of opposed faces. The cathode current collector 21A is made of, for example, a metal foil such as an aluminum foil. The cathode active material layer 21B contains, for example, one or more cathode active materials capable of inserting and extracting lithium. If necessary, the cathode active material layer 21B may contain an electrical conductor such as a carbon material and a binder such as polyvinylidene fluoride.

As a cathode active material capable of inserting and extracting lithium, for example, a lithium-containing compound such as a lithium oxide, a lithium sulfide, an intercalation compound containing lithium, and a phosphate compound can be cited. One thereof can be used singly, or two or more thereof can be used by mixing. Specially, a complex oxide containing lithium and transition metal elements or a phosphate compound containing lithium and transition metal elements is preferable. In particular, a compound containing at least one of cobalt, nickel, manganese, iron, aluminum, vanadium, and titanium as a transition metal element is preferable. The chemical formula thereof is expressed by, for example, LiₓMIO₂ or Li_{y}MIIPO₄. In the formula, MI and MII represent one or more transition metal elements. Values of x and y vary according to charge and discharge states of the battery, and are generally in the range of 0.05≦x≦1.10 and 0.05≦y≦1.10.

As a specific example of the complex oxide containing lithium and transition metal elements, a lithium-cobalt complex oxide (LiₓCoO₂), a lithium-nickel complex oxide (LiₓNiO₂), a lithium-nickel-cobalt complex oxide (LiₓNi_{1-z}Co_{z}O₂ (z<1)), a lithium-nickel-cobalt-manganese complex oxide (LiₓNi_{1(1-v-w})CoᵥMn_{w}O₂ (v+w<1)), lithium-manganese complex oxide having a spinel structure (LiMn₂O₄) and the like can be cited. As a specific example of the phosphate compound containing lithium and transition metal elements, for example, lithium-iron phosphate compound (LiFePO₄) or a lithium-iron-manganese phosphate compound (LiFe₁₋ᵤMnᵤPO₄ (u<1)) can be cited.

As a cathode active material capable of inserting and extracting lithium, a compound not containing lithium can be cited. For example, a metal sulfide such as TiS₂ and MoS₂, an oxide such as V₂O₅, and NbSe₂ can be cited. Further, as a cathode active material capable of inserting and extracting lithium, a high molecular weight material can be cited. For example, polyaniline or polythiophene can be cited.

As the cathode 21, for example, the anode 22 has a structure in which an anode active material layer 22B is provided on the both faces or one face of an anode current collector 22A having a pair of opposed faces. The anode current collector 22A is made of, for example, a metal foil such as a copper foil.

The anode active material layer 22B contains, for example, the anode active material of this embodiment, and if necessary contains a binder such as polyvinylidene fluoride. Since the anode active material layer 22B contains the anode active material of this embodiment, in the secondary battery, a high capacity can be obtained, and the cycle characteristics can be improved. Further, the anode active material layer 22B may contain other anode active material in addition to the anode active material of this embodiment, or may contain other material such as an electrical conductor. As other anode active material, for example, a carbon material capable of inserting and extracting lithium can be cited. The carbon material is preferable since the carbon material can improve charge and discharge cycle characteristics and functions as an electrical conductor as well. As a carbon material, for example, the carbon material similar to that used in forming the anode active material can be cited.

The carbon material ratio is preferably in the range from 1 wt % to 95 wt % to the anode active material of this embodiment. When the carbon material ratio is small, the conductivity of the anode 22 is decreased. Meanwhile, when the carbon material ratio is large, the battery capacity is decreased.

The separator 23 separates the cathode 21 from the anode 22, prevents current short circuit due to contact of both electrodes, and lets through lithium ions. The separator 23 is made of, for example, a porous film made of a synthetic resin such as polytetrafluoroethylene, polypropylene, and polyethylene, or a ceramics porous film. The separator 23 may have a structure in which two or more of the foregoing porous films are layered.

The electrolytic solution impregnated in the separator 23 contains, for example, a solvent and an electrolyte salt dissolved in the solvent. As a solvent, for example, propylene carbonate, ethylene carbonate, diethyl carbonate, dimethyl carbonate, 1,2-dimethoxyethane, 1,2-diethoxyethane, y-butyrolactone, tetrahydrofuran, 2-methyltetrahydrofuran, 1,3-dioxolane, 4-methyl-1,3-dioxolane, diethyl ether, sulfolane, methyl sulfolane, acetonitrile, propionitrile, anisole, ester acetate, ester butyrate, ester propionate or the like can be cited. The solvent may be used singly, or two or more thereof may be used by mixing.

The solvent more preferably contains a cyclic carbonate derivative having halogen atom. Thereby, decomposition reaction of the solvent in the anode 22 can be inhibited, and cycle characteristics can be improved. As a specific example of such a cyclic carbonate derivative, 4-fluoro-1,3-dioxolane-2-one expressed in Chemical formula 1-(1), 4-difluoro-1,3-dioxolane-2-one expressed in Chemical formula 1-(2), 4,5-difluoro-1,3-dioxolane-2-one expressed in Chemical formula 1-(3), 4-difluoro-5-fluoro-1,3-dioxolane-2-one expressed in Chemical formula 1-(4), 4-chrolo-1,3-dioxolane-2-one expressed in Chemical formula 1-(5), 4,5-dichrolo-1,3-dioxolane-2-one expressed in Chemical formula 1-(6), 4-bromo-1,3-dioxolane-2-one expressed in Chemical formula 1-(7), 4-iodine-1,3-dioxolane-2-one expressed in Chemical formula 1-(8), 4-fluoromethyl-1,3-dioxolane-2-one expressed in Chemical formula 1-(9), 4-trifluoromethyl-1,3-dioxolane-2-one expressed in Chemical formula i-(10) or the like can be cited. Specially, 4-fluoro-1,3-dioxolane-2-one is desirable, since higher effects can be thereby obtained. One of the cyclic carbonate derivatives may be used singly, or a plurality thereof may be used by mixing.

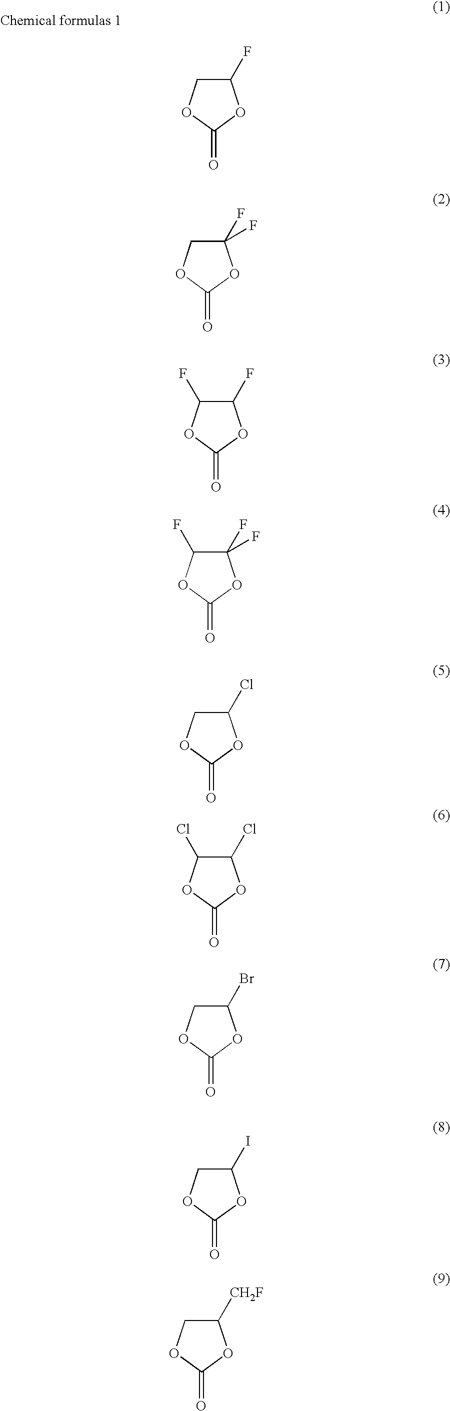

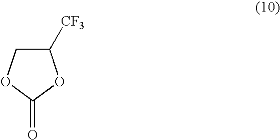

The solvent may be composed of only the cyclic carbonate derivative. However, the cyclic carbonate derivative is preferably mixed with a low-boiling point solvent with a boiling point of 150 deg C. or less in the ambient pressure (1.01325×10⁵ Pa), since ion conductivity can be thereby improved. The cyclic carbonate derivative content is preferably in the range from 0.1 wt % to 80 wt % to the whole solvent. When the content of cyclic carbonate derivative is small, effects to inhibit decomposition reaction of the solvent in the anode 22 are not sufficient. Meanwhile, when the content of cyclic carbonate derivative is large, the viscosity becomes high, and the ion conductivity becomes low.

When the cyclic carbonate derivative is contained as a solvent, a cyclic sulfur compound is preferably further contained. Thereby, decomposition reaction of the solvent can be more inhibited, and cycle characteristics can be more improved. As a cyclic sulfur compound, a compound shown in Chemical formula 2 can be preferably cited, since higher effects can be thereby obtained.

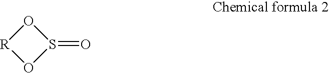

R represents a group expressed by —(CH₂)ₙ—, or a group obtained by substituting at least part of hydrogen thereof with a substituent. n is 2, 3, or 4.

Specific examples of such a compound include 1,3,2-dioxathiolane-2-oxide (ethylene sulfide) shown in Chemical formula 3, 1,3,2-dioxathiane-2-oxide, 1,2-oxathiolane-2,2-dioxide, 1,3,2-dioxathiolane-2,2-oxide, and derivatives thereof.

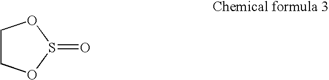

The content of cyclic sulfur compound is preferably in the range from 0.1 wt % to 10 wt % to the whole solvent. When the content is small, effect to inhibit decomposition reaction of the solvent is not sufficient. When the content is large, internal resistance is increased.

As an electrolyte salt, for example, a lithium salt can be cited. The lithium salt may be used singly, or two or more thereof may be used by mixing. As a lithium salt, for example, LiClO₄, LiAsF₆, LiPF₆, LiBF₄, LiB(C₆H₅)₄, CH₃SO₃Li, CF₃SO₃Li, LiCl, LiBr or the like can be cited. As an electrolyte salt, though the lithium salt is preferably used, other electrolyte salt may be used. Lithium ions contributing to charge and discharge are enough if supplied from the cathode 21 and the like.

The secondary battery can be manufactured, for example, as follows.

First, for example, a cathode active material, and if necessary an electrical conductor and a binder are mixed to prepare a cathode mixture, which is dispersed in a solvent such as N-methyl-2-pyrrolidone to form cathode mixture slurry. Next, the cathode current collector 21A is coated with the cathode mixture slurry, which is dried and compression-molded to form the cathode active material layer 21B and thereby forming the cathode 21. Subsequently, the cathode lead 25 is welded to the cathode 21.

Further, for example, the anode active material of this embodiment, and if necessary other anode active material and a binder are mixed to prepare an anode mixture, which is dispersed in a solvent such as N-methyl-2-pyrrolidone to form anode mixture slurry. Next, the anode current collector 22A is coated with the anode mixture slurry, which is dried and compression-molded to form the anode active material layer 22B and forming the anode 22. Subsequently, the anode lead 26 is welded to the anode 22.

After that, the cathode 21 and the anode 22 are wound with the separator 23 in between. The end of the cathode lead 25 is welded to the safety valve mechanism 15, and the end of the anode lead 26 is welded to the battery can 11. The wound cathode 21 and the wound anode 22 are sandwiched between the pair of insulating plates 12 and 13, and contained inside the battery can 11. Next, the electrolytic solution is injected into the battery can 11. After that, at the open end of the battery can 11, the battery cover 14, the safety valve mechanism 15, and the PTC device 16 are fixed by being caulked with the gasket 17. The secondary battery shown in FIG. 1 is thereby completed.

In the secondary battery, when charged, for example, lithium ions are extracted from the cathode 21 and inserted in the anode 22 through the electrolytic solution. When discharged, for example, lithium ions are extracted from the anode 22 and inserted in the cathode 21 through the electrolytic solution. Here, the anode 22 contains the anode active material containing tin, iron, and carbon at the foregoing ratio. Therefore, cycle characteristics are improved while a high capacity is maintained.

As above, according to the anode active material of this embodiment, since tin is contained as an element, a high capacity can be obtained. Further, iron is contained as an element, and the iron ratio to the total of tin and iron is from 26.4 wt % to 48.5 wt %. Therefore, cycle characteristics can be improved while a high capacity is maintained. Further, since as an element, carbon is contained in the range from 11.9 wt % to 29.7 wt %, cycle characteristics can be more improved. Therefore, according to the secondary battery of this embodiment, since the anode active material is used, a high capacity can be obtained, and superior cycle characteristics can be obtained.

Further, when silver is contained in the anode active material as an element, reactivity to the electrolyte can be decreased, and cycle characteristics can be more improved. In particular, when the silver content in the anode active material is from 0.1 wt % to 9.9 wt %, a higher capacity can be obtained.

Further, when silicon is contained in the anode active material as an element, a higher capacity can be obtained.

Furthermore, when at least one from the group consisting of aluminum, titanium, vanadium, chromium, niobium, and tantalum, and at least one from the group consisting of cobalt, nickel, copper, zinc, gallium, and indium are contained in the anode active material, cycle characteristics can be more improved. In particular, when the respective contents are from 0.1 wt % to 9.9 wt % and from 0.5 wt % to 14.9 wt %, a higher capacity can be obtained.

In addition, when a cyclic carbonate derivative having halogen atom is contained in the electrolytic solution, decomposition reaction of the solvent in the anode 22 can be inhibited, and cycle characteristics can be further improved. Further, a cyclic sulfur compound is contained in addition to the cyclic carbonate derivative, decomposition reaction of the solvent can be more inhibited, and a higher effect can be obtained.

(Second Secondary Battery)

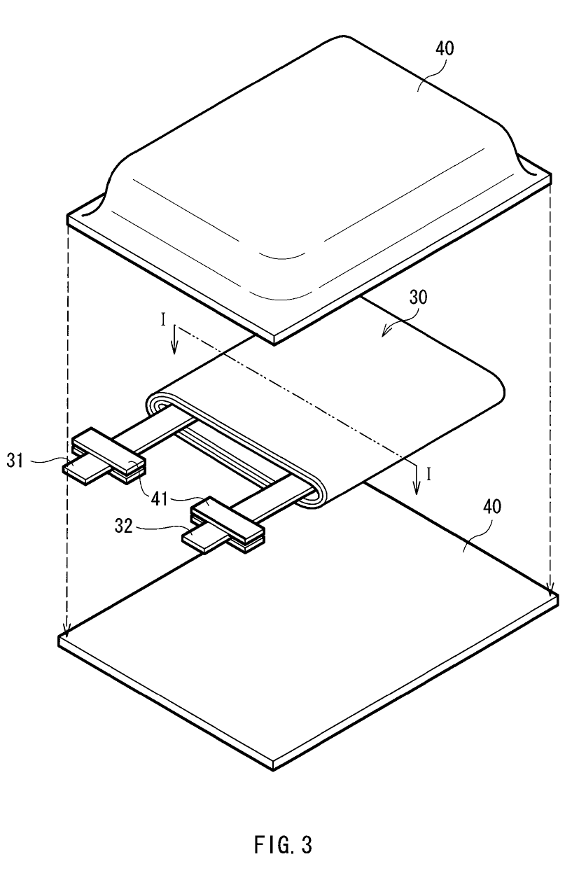

FIG. 3 shows a structure of a second secondary battery. In the secondary battery, a spirally wound electrode body 30 on which a cathode lead 31 and an anode lead 32 are attached is contained inside a film package member 40. Therefore, the size, the weight, and the thickness thereof can be decreased.

The cathode lead 31 and the anode lead 32 are directed from inside to outside of the package member 40 in the same direction, for example. The cathode lead 31 and the anode lead 32 are respectively made of, for example, a metal material such as aluminum, copper, nickel, and stainless, and are in the shape of thin plate or mesh.

The package member 40 is made of a rectangular aluminum laminated film in which, for example, a nylon film, an aluminum foil, and a polyethylene film are bonded together in this order. The package member 40 is arranged, for example, so that the polyethylene film side and the spirally wound electrode body 30 are opposed to each other, and the respective outer edges are contacted to each other by fusion bonding or an adhesive. Adhesive films 41 to protect from outside air intrusion are inserted between the package member 40 and the cathode lead 31, the anode lead 32. The adhesive film 41 is made of a material having contact characteristics to the cathode lead 31 and the anode lead 32, for example, is made of a polyolefin resin such as polyethylene, polypropylene, modified polyethylene, and modified polypropylene.

The package member 40 may be made of a laminated film having other structure, a high molecular weight film such as polypropylene, or a metal film, instead of the foregoing aluminum laminated film.

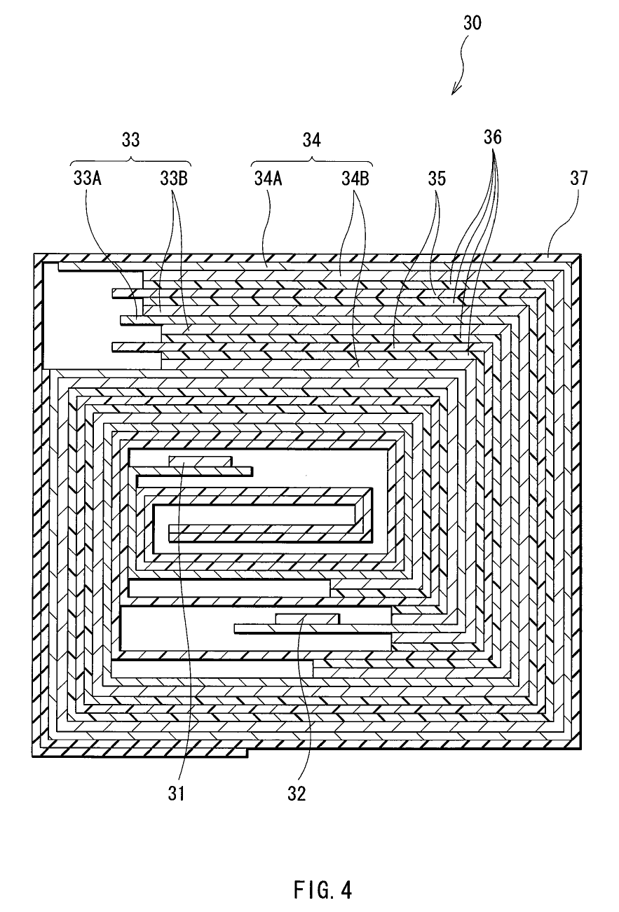

FIG. 4 shows a cross sectional structure taken along line I-I of the spirally wound electrode body 30 shown in FIG. 3. In the spirally wound electrode body 30, a cathode 33 and an anode 34 are layered with a separator 35 and an electrolyte layer 36 in between and wound. The outermost periphery thereof is protected by a protective tape 37.

The cathode 33 has a structure in which a cathode active material layer 33B is provided on one face or the both faces of a cathode current collector 33A. The anode 34 has a structure in which an anode active material layer 34B is provided on one face or the both faces of an anode current collector 34A. Arrangement is made so that the anode active material layer 34B side is opposed to the cathode active material layer 33B. Structures of the cathode current collector 33A, the cathode active material layer 33B, the anode current collector 34A, the anode active material layer 34B, and the separator 35 are similar to of the cathode current collector 21A, the cathode active material layer 21B, the anode current collector 22A, the anode active material layer 22B, and the separator 23, respectively described above.

The electrolyte layer 36 is so-called gelatinous, containing an electrolytic solution and a high molecular weight compound to become a holding body, which holds the electrolytic solution. The gelatinous electrolyte layer 36 is preferable, since a high ion conductivity can be thereby obtained, and leakage of the battery can be thereby prevented. The structure of the electrolytic solution (that is, a solvent and an electrolyte salt) is similar to of the cylindrical-type secondary battery shown in FIG. 1. As a high molecular weight compound, for example, a fluorinated high molecular weight compound such as polyvinylidene fluoride and a copolymer of vinylidene fluoride and hexafluoropropylene, an ether high molecular weight compound such as polyethylene oxide and a cross-linked body containing polyethylene oxide, polyacrylonitrile or the like can be cited. In particular, in view of redox stability, a fluorinated high molecular weight compound is desirable.

The secondary battery can be manufactured, for example, as follows.

First, the cathode 33 and the anode 34 are respectively coated with a precursor solution containing a solvent, an electrolyte salt, a high molecular weight compound, and a mixed solvent. The mixed solvent is volatilized to form the electrolyte layer 36. After that, the cathode lead 31 is welded to the end of the cathode current collector 33A, and the anode lead 32 is welded to the end of the anode current collector 34A. Next, the cathode 33 and the anode 34 formed with the electrolyte layer 36 are layered with the separator 35 in between to obtain a lamination. After that, the lamination is wound in the longitudinal direction, the protective tape 37 is adhered to the outermost periphery thereof to form the spirally wound electrode body 30. Lastly, for example, the spirally wound electrode body 30 is sandwiched between the package members 40, and outer edges of the package members 40 are contacted by thermal fusion bonding or the like to enclose the spirally wound electrode body 30. Then, the adhesive films 41 are inserted between the cathode lead 31, the anode lead 32 and the package member 40. Thereby, the secondary battery shown in FIGS. 3 and 4 is completed.

Further, the secondary battery may be fabricated as follows. First, as described above, the cathode 33 and the anode 34 are formed, and the cathode lead 31 and the anode lead 32 are attached on the cathode 33 and the anode 34. After that, the cathode 33 and the anode 34 are layered with the separator 35 in between and wound. The protective tape 37 is adhered to the outermost periphery thereof, and a spirally wound body as a precursor of the spirally wound electrode body 30 is formed. Next, the spirally wound body is sandwiched between the package members 40, the outermost peripheries except for one side are thermally fusion-bonded to obtain a pouched state, and the spirally wound body is contained inside the package member 40. Subsequently, an electrolytic composition containing a solvent, an electrolyte salt, a monomer as a raw material for the high molecular weight compound, and if necessary a polymerization initiator and other material such as a polymerization inhibitor is prepared, which is injected into the package member 40.

After the electrolytic composition is injected, the opening of the package member 40 is thermally fusion-bonded and hermetically sealed in the vacuum atmosphere. Next, the resultant is heated to polymerize the monomer to obtain a high molecular weight compound. Thereby, the gelatinous electrolyte layer 36 is formed, and the secondary battery shown in FIGS. 3 and 4 is assembled.

The secondary battery works similarly to the first secondary battery and provides similar effects.

### EXAMPLES

Further, specific examples of the present invention will be described in detail.

### Examples 1-1 to 1-10

First, an anode active material was formed. As raw materials, tin powder, iron powder, and carbon powder were prepared. Tin powder and iron powder were alloyed to form tin-iron alloy powder, and then carbon powder was added to the powder and dry-blended. For the raw material ratio, the iron ratio to the total of tin and iron (hereinafter referred to as Fe/(Sn+Fe) ratio) was constantly maintained at 32 wt %, and the raw material ratio of carbon was changed in the range from 12 wt % to 30 wt %. Subsequently, 20 g of the mixture and about 400 g of corundum being 9 mm in diameter were set in the reaction vessel of a planetary ball mill of Ito Seisakusho Co., Ltd. Next, inside of the reaction vessel was substituted with the argon atmosphere. Then, 10 minute operation at 250 rpm and 10 minute recess were repeated until the total operation time became 30 hours. After that, the reaction vessel was cooled down to room temperatures and the synthesized anode active material powder was taken out. Coarse grains were removed through a 280-mesh sieve.

TABLE 1

| | | | | | | | Initial | |
|---|---|---|---|---|---|---|---|---|
| | Raw material ratio | | | Analytical value | | | charging | Capacity |
| | (wt %) | | | (wt %) | | | capacity | retention |
| | Fe | Sn | C | Fe | Sn | C | (mAh/g) | ratio (%) |
| Example 1-1 | 28.2 | 59.8 | 12.0 | 28.3 | 59.4 | 11.9 | 556.6 | 60 |
| Example 1-2 | 27.5 | 58.5 | 14.0 | 27.7 | 58.1 | 13.9 | 581.8 | 72 |
| Example 1-3 | 26.9 | 57.1 | 16.0 | 27.1 | 56.7 | 15.8 | 598.3 | 80 |
| Example 1-4 | 26.2 | 55.8 | 18.0 | 26.4 | 55.4 | 17.8 | 634.0 | 83 |
| Example 1-5 | 25.6 | 54.4 | 20.0 | 25.8 | 54.0 | 19.8 | 644.2 | 85 |
| Example 1-6 | 25.0 | 53.0 | 22.0 | 25.2 | 52.6 | 21.8 | 647.1 | 84 |
| Example 1-7 | 24.3 | 51.7 | 24.0 | 24.4 | 51.4 | 23.8 | 642.3 | 82 |
| Example 1-8 | 23.7 | 50.3 | 26.0 | 23.9 | 50.0 | 25.7 | 629.6 | 79 |
| Example 1-9 | 23.0 | 49.0 | 28.0 | 23.2 | 48.7 | 27.7 | 612.5 | 74 |
| Example 1-10 | 22.4 | 47.6 | 30.0 | 22.6 | 47.3 | 29.7 | 598.4 | 61 |
| Comparative | 32.0 | 68.0 | 0 | 32.3 | 67.5 | 0 | 122.4 | 0 |
| example 1-1 | | | | | | | | |
| Comparative | 30.1 | 63.9 | 6.0 | 30.4 | 63.5 | 5.9 | 478.7 | 4 |
| example 1-2 | | | | | | | | |
| Comparative | 28.8 | 61.2 | 10.0 | 29.0 | 60.8 | 9.9 | 541.7 | 28 |
| example 1-3 | | | | | | | | |
| Comparative | 21.8 | 46.2 | 32.0 | 22.0 | 45.9 | 31.7 | 578.6 | 46 |
| example 1-4 | | | | | | | | |
| Comparative | 19.2 | 40.8 | 40.0 | 19.4 | 40.5 | 39.6 | 369.3 | 23 |
| example 1-5 | | | | | | | | |

For the obtained anode active material, the composition was analyzed. The carbon content was measured by a carbon sulfur analyzer. The tin content and the iron content were measured by ICP (Inductively Coupled Plasma) optical emission spectroscopy. The analytic values are shown in Table 1. Further, when XPS was performed, Peak P1 was obtained. When Peak P1 was analyzed, Peak P2 of surface contamination carbon and Peak P3 of C1s in the anode active material on the energy side lower than of Peak P2 were obtained. For all Examples 1-1 to 1-10, Peak P3 was obtained in the region lower than 284.5 eV. That is, it was confirmed that carbon in the anode active material was bonded to other element.

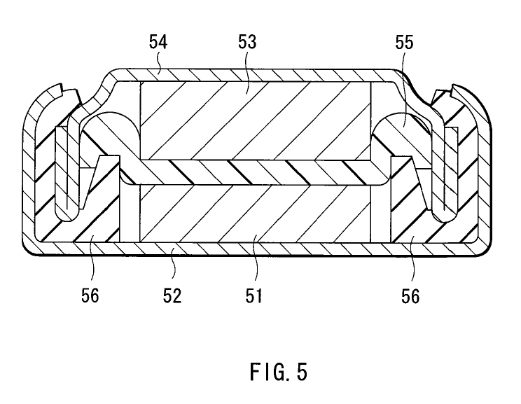

Next, a coin type secondary battery as shown in FIG. 5 was fabricated by using the anode active material powder of Examples 1-1 to 1-10, and the initial charging capacity and the cycle characteristics were examined. In the coin type battery, a test electrode 51 using the anode active material of this embodiment was contained in a package member 52, a counter electrode 53 was attached to a package member 54, the both electrodes were layered with a separator 55 impregnated with an electrolytic solution in between, and the resultant was caulked with a gasket 56.

The test electrode 51 was formed as follows. The obtained anode active material powder, graphite as an electrical conductor and other anode active material, acetylene black as an electrical conductor, and polyvinylidene fluoride as a binder were mixed, the mixture was dispersed in an appropriate solvent to obtain slurry. A copper foil current collector was coated with the slurry, which was dried. The resultant was punched out into a pellet being 15.2 mm in diameter.

For the counter electrode 53, a punched out metal lithium plate being 15.5 mm in diameter was used. For the electrolytic solution, a solution obtained by dissolving LiPF₆ as an electrolyte salt in a mixed solvent of ethylene carbonate, propylene carbonate, and dimethyl carbonate was used.

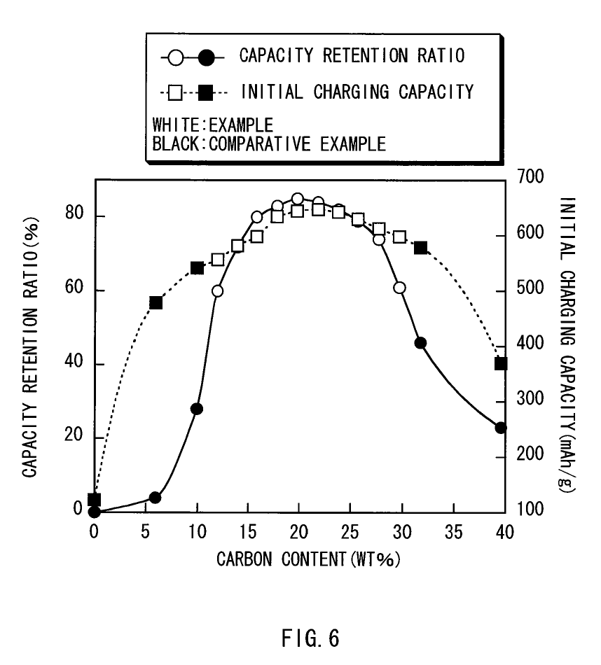

The initial charging capacity was obtained as follows. After constant current charge was performed at a constant current of 1 mA until the battery voltage reached 0.2 mV, constant voltage charge was performed at a constant voltage of 0.2 mV until the current reached 10 μA. Then, the charging capacity per unit weight of the weight obtained by subtracting the weight of the copper foil current collector and the binder from the weight of the test electrode 51 was obtained. Here, charge means lithium insertion reaction with the anode active material. The results are shown in Table 1 and FIG. 6.

Further, cycle characteristics were measured as follows. First, after constant current charge was performed at a constant current of 1 mA until the battery voltage reached 0.2 mV, constant voltage charge was performed at a constant voltage of 0.2 mV until the current reached 10 μA. Subsequently, constant current discharge was performed at a constant current of 1 mA until the battery voltage reached 1200 mV, and thereby charge and discharge at the first cycle was performed.

On and after the second cycle, constant current charge was performed at a constant current of 2 mA until the battery voltage reached 0.2 mV, constant voltage charge was performed at a constant voltage of 0.2 mV until the current reached 10 μA. Subsequently, constant current discharge was performed at a constant current of 2 mA until the battery voltage reached 1200 mV. For cycle characteristics, the capacity retention ratio at the 50th cycle to the discharging capacity at the second cycle ((discharging capacity at the 50th cycle/discharging capacity at the second cycle)×100 (%)) was obtained. The results are shown in Table 1 and FIG. 6.

As Comparative example 1-1 relative to Examples 1-1 to 1-10, an anode active material was synthesized and a secondary battery was fabricated in the same manner as in Examples 1-1 to 1-10, except that the carbon powder was not used as a raw material. Further, as Comparative examples 1-2 to 1-5, anode active materials were synthesized and secondary batteries were fabricated in the same manner as in Examples 1-1 to 1-10, except that the raw material ratio of carbon powder was changed as shown in Table 1. For the anode active materials of Comparative examples 1-1 to 1-5, the composition was analyzed in the same manner as in Examples 1-1 to 1-10. The results are shown in Table 1. Further, when XPS was performed, Peak P1 was obtained in Comparative examples 1-2 to 1-5. When Peak P1 was analyzed, Peak P2 of surface contamination carbon and Peak P3 of C1s in the anode active material were obtained similar to in Examples 1-1 to 1-10. Peak P3 was obtained in the region lower than 284.5 eV. That is, it was confirmed that at least part of carbon contained in the anode active material was bonded to other element. Meanwhile, in Comparative example 1-1, Peak P4 was obtained. When Peak P4 analysis was performed, only Peak P2 of surface contamination carbon was obtained.

Further, for the secondary batteries, the initial charging capacity and the cycle characteristics were measured in the same manner as in Examples 1-1 to 1-10. The results are shown in Table 1 and FIG. 6.

As evidenced by Table 1 and FIG. 6, according to Examples 1-1 to 1-10, in which the carbon content in the anode active material was from 11.9 wt % to 29.7 wt %, the capacity retention ratio could be significantly improved than in Comparative examples 1-1 to 1-5 in which the carbon content was out of the foregoing range. Further, according to Examples 1-1 to 1-10, the initial discharging capacity could be improved as well.

Further, when the carbon content in the anode active material was in the range from 13.9 wt % to 27.7 wt %, in particular when the carbon content in the anode active material was in the range from 15.8 wt % to 23.8 wt %, higher values could be obtained.

That is, it was found that when the carbon content was in the range from 11.9 wt % to 29.7 wt %, more preferably in the range from 13.9 wt % to 27.7 wt %, and much more preferably in the range from 15.8 wt % to 23.8 wt %, the capacity and the cycle characteristics could be improved.

### Examples 2-1 to 2-8

Anode active materials and secondary batteries were fabricated in the same manner as in Examples 1-1 to 1-10, except that the raw material ratio among tin, iron, and carbon was changed as shown in Table 2. Specifically, the raw material ratio of carbon was constantly maintained at 30.0 wt %, and the Fe/(Sn+Fe) ratio was changed in the range from 26 wt % to 48 wt %.

TABLE 2

| | Raw material | | | | | | | Initial | |
|---|---|---|---|---|---|---|---|---|---|
| | ratio | | | Analytical value | | | | charging | Capacity |
| | (wt %) | | | (wt %) | | | | capacity | retention |
| | Fe | Sn | C | Fe | Sn | C | Fe/(Sn + Fe) | (mAh/g) | ratio (%) |
| Example 2-1 | 18.2 | 51.8 | 30.0 | 18.4 | 51.4 | 29.7 | 26.4 | 596.7 | 53 |
| Example 2-2 | 20.3 | 49.7 | 30.0 | 20.6 | 49.4 | 29.7 | 29.4 | 605.3 | 60 |
| Example 1-10 | 22.4 | 47.6 | 30.0 | 22.6 | 47.3 | 29.7 | 32.3 | 598.4 | 61 |
| Example 2-3 | 23.8 | 46.2 | 30.0 | 24.1 | 45.9 | 29.7 | 34.4 | 580.2 | 63 |
| Example 2-4 | 25.2 | 44.8 | 30.0 | 25.5 | 44.5 | 29.7 | 36.4 | 553.8 | 63 |
| Example 2-5 | 27.3 | 42.7 | 30.0 | 27.6 | 42.4 | 29.7 | 39.4 | 532.0 | 64 |
| Example 2-6 | 29.4 | 40.6 | 30.0 | 29.7 | 40.3 | 29.7 | 42.4 | 502.1 | 66 |
| Example 2-7 | 31.5 | 38.5 | 30.0 | 31.8 | 38.2 | 29.7 | 45.4 | 466.0 | 69 |
| Example 2-8 | 33.6 | 36.4 | 30.0 | 34.0 | 36.2 | 29.7 | 48.4 | 436.9 | 72 |
| Comparative | 13.3 | 56.7 | 30.0 | 13.5 | 56.3 | 29.7 | 19.3 | 529.0 | 0 |
| example 2-1 | | | | | | | | | |
| Comparative | 14.7 | 55.3 | 30.0 | 14.9 | 54.9 | 29.7 | 21.4 | 549.6 | 5 |
| example 2-2 | | | | | | | | | |
| Comparative | 17.5 | 52.5 | 30.0 | 17.7 | 52.1 | 29.7 | 25.4 | 594.5 | 43 |
| example 2-3 | | | | | | | | | |
| Comparative | 34.3 | 35.7 | 30.0 | 34.7 | 35.5 | 29.7 | 49.4 | 414.0 | 74 |
| example 2-4 | | | | | | | | | |
| Comparative | 35.0 | 35.0 | 30.0 | 35.3 | 34.8 | 29.7 | 50.4 | 386.7 | 75 |
| example 2-5 | | | | | | | | | |

As Comparative examples 2-1 to 2-5 relative to Examples 2-1 to 2-8, anode active materials and secondary batteries were fabricated in the same manner as in Examples 2-1 to 2-10, except that the Fe/(Sn+Fe) ratio was changed as shown in Table 2. The Fe/(Sn+Fe) ratios in Comparative examples 2-1 to 2-5 were 19 wt %, 21 wt %, 25 wt %, 49 wt %, or 50 wt %, respectively.

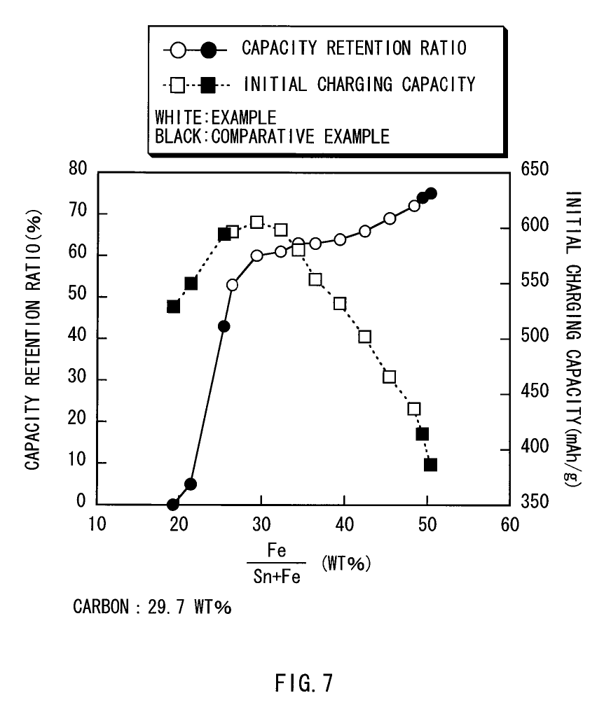

For the obtained anode active materials of Examples 2-1 to 2-8 and Comparative examples 2-1 to 2-5, when XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element. Further, for the secondary batteries, the initial charging capacity and the cycle characteristics were measured in the same manner as in Examples 1-1 to 1-10. The results are shown in Table 2 and FIG. 7.

As evidenced by Table 2 and FIG. 7, according to Examples 1-10 and 2-1 to 2-8, in which the Fe/(Sn+Fe) ratio of the synthesized anode active material was from 26.4 wt % to 48.4 wt %, both the capacity retention ratio and the initial charging capacity could be improved than in Comparative examples 2-1 to 2-5 in which the Fe/(Sn+Fe) ratio was out of the foregoing range. In particular, in Examples 1-10 and 2-2 to 2-7, in which the Fe/(Sn+Fe) ratio was from 29.4 wt % to 45.4 wt %, higher values were obtained.

That is, it was found that when the Fe/(Sn+Fe) ratio in the anode active material was from 26.4 wt % to 48.4 wt %, more preferably from 29.4 wt % to 45.4 wt %, the capacity and the cycle characteristics could be improved.

### Examples 3-1 to 3-8

Anode active materials and secondary batteries were formed in the same manner as in Examples 1-1 to 1-10, except that the raw material ratio between tin, iron, and carbon was changed as shown in Table 3. Specifically, the raw material ratio of carbon was constantly maintained at 20.0 wt %, and the Fe/(Sn+Fe) ratio was changed in the range from 26 wt % to 48 wt %.

TABLE 3

| | | | | | | | | Initial | |
|---|---|---|---|---|---|---|---|---|---|
| | Raw material | | | Analytical value | | | | charging | Capacity |
| | ratio (wt %) | | | (wt %) | | | | capacity | retention |
| | Fe | Sn | C | Fe | Sn | C | Fe/(Sn + Fe) | (mAh/g) | ratio (%) |
| Example 3-1 | 20.8 | 59.2 | 20.0 | 21.1 | 58.8 | 19.8 | 26.4 | 642.3 | 76 |
| Example 3-2 | 23.2 | 56.8 | 20.0 | 23.5 | 56.4 | 19.8 | 29.4 | 651.6 | 82 |
| Example 1-5 | 25.6 | 54.4 | 20.0 | 25.8 | 54.0 | 19.8 | 32.3 | 644.2 | 85 |
| Example 3-3 | 27.2 | 52.8 | 20.0 | 27.5 | 52.4 | 19.8 | 34.4 | 624.5 | 85 |
| Example 3-4 | 28.8 | 51.2 | 20.0 | 29.1 | 50.9 | 19.8 | 36.4 | 596.1 | 86 |
| Example 3-5 | 31.2 | 48.8 | 20.0 | 31.5 | 48.5 | 19.8 | 39.4 | 572.7 | 87 |
| Example 3-6 | 33.6 | 46.4 | 20.0 | 33.9 | 46.1 | 19.8 | 42.4 | 540.5 | 88 |
| Example 3-7 | 36.0 | 44.0 | 20.0 | 36.3 | 43.7 | 19.8 | 45.4 | 501.6 | 89 |
| Example 3-8 | 38.4 | 41.6 | 20.0 | 38.7 | 41.3 | 19.8 | 48.4 | 470.3 | 90 |
| Comparative | 15.2 | 64.8 | 20.0 | 15.4 | 64.5 | 19.8 | 19.3 | 569.4 | 0 |
| example 3-1 | | | | | | | | | |
| Comparative | 16.8 | 63.2 | 20.0 | 17.0 | 62.8 | 19.8 | 21.3 | 591.6 | 28 |
| example 3-2 | | | | | | | | | |
| Comparative | 20.0 | 60.0 | 20.0 | 20.3 | 59.6 | 19.8 | 25.4 | 639.9 | 69 |
| example 3-3 | | | | | | | | | |
| Comparative | 39.2 | 40.8 | 20.0 | 39.5 | 40.5 | 19.8 | 49.4 | 445.6 | 91 |
| example 3-4 | | | | | | | | | |
| Comparative | 40.0 | 40.0 | 20.0 | 40.3 | 39.7 | 19.8 | 50.4 | 416.3 | 91 |
| example 3-5 | | | | | | | | | |

As Comparative examples 3-1 to 3-5 relative to Examples 3-1 to 3-8, anode active materials and secondary batteries were fabricated in the same manner as in Examples 3-1 to 3-8, except that the Fe/(Sn+Fe) ratio was changed as shown in Table 3. The Fe/(Sn+Fe) ratios in Comparative examples 3-1 to 3-5 were 19 wt %, 21 wt %, 25 wt %, 49 wt %, and 50 wt %, respectively.

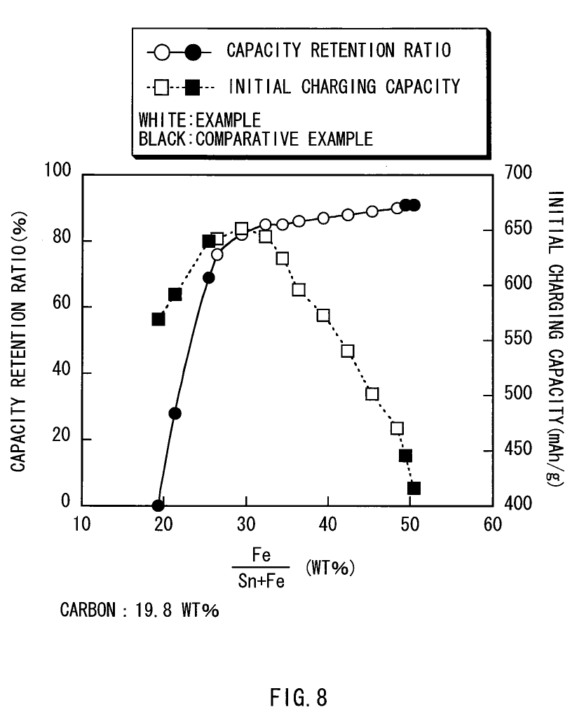

For the anode active materials of Examples 3-1 to 3-8 and Comparative examples 3-1 to 3-5, composition analysis was performed in the same manner as in Examples 1-1 to 1-10. The results are shown in Table 3. Further, when XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element. Further, for the secondary batteries, the initial charging capacity and the cycle characteristics were measured in the same manner as in Examples 1-1 to 1-10. The results are shown in Table 3 and FIG. 8.

As evidenced by Table 3 and FIG. 8, according to Examples 1-5 and 3-1 to 3-8, in which the Fe/(Sn+Fe) ratio of the synthesized anode active material was from 26.4 wt % to 48.4 wt %, both the capacity retention ratio and the initial charging capacity could be improved than in Comparative examples 3-1 to 3-5 in which the Fe/(Sn+Fe) ratio was out of the foregoing range. In particular, in Examples 1-5 and 3-2 to 3-7, in which the Fe/(Sn+Fe) ratio was in the range from 29.4 wt % to 45.4 wt %, higher values were obtained.

That is, it was found that when the Fe/(Sn+Fe) ratio in the anode active material was from 26.4 wt % to 48.4 wt %, more preferably in the range from 29.4 wt % to 45.4 wt %, the capacity and the cycle characteristics could be improved even when the carbon content was 19.8 wt %.

### Examples 4-1 to 4-8

Anode active materials and secondary batteries were formed in the same manner as in Examples 1-1 to 1-10, except that the raw material ratio between tin, iron, and carbon was changed as shown in Table 4. Specifically, the raw material ratio of carbon was constantly maintained at 12.0 wt %, and the Fe/(Sn+Fe) ratio was changed in the range from 26 wt % to 48 wt %.

TABLE 4

| | Raw material | | | | | | | Initial | |
|---|---|---|---|---|---|---|---|---|---|
| | ratio | | | Analytical value | | | | charging | Capacity |
| | (wt %) | | | (wt %) | | | | capacity | retention |
| | Fe | Sn | C | Fe | Sn | C | Fe/(Sn + Fe) | (mAh/g) | ratio (%) |
| Example 4-1 | 22.9 | 65.1 | 12.0 | 23.1 | 64.5 | 11.9 | 26.4 | 554.9 | 53 |
| Example 4-2 | 25.5 | 62.5 | 12.0 | 25.7 | 61.9 | 11.9 | 29.3 | 563.0 | 59 |
| Example 1-1 | 28.2 | 59.8 | 12.0 | 28.3 | 59.4 | 11.9 | 32.3 | 556.6 | 60 |
| Example 4-3 | 29.9 | 58.1 | 12.0 | 30.2 | 57.5 | 11.9 | 34.4 | 539.6 | 61 |
| Example 4-4 | 31.7 | 56.3 | 12.0 | 32.0 | 55.9 | 11.9 | 36.4 | 515.0 | 62 |
| Example 4-5 | 34.3 | 53.7 | 12.0 | 34.6 | 53.1 | 11.9 | 39.5 | 494.8 | 64 |
| Example 4-6 | 37.0 | 51.0 | 12.0 | 37.3 | 50.6 | 11.9 | 42.9 | 467.0 | 65 |
| Example 4-7 | 39.6 | 48.4 | 12.0 | 39.9 | 47.9 | 11.9 | 45.4 | 433.4 | 65 |
| Example 4-8 | 42.2 | 45.8 | 12.0 | 42.6 | 45.4 | 11.9 | 48.4 | 406.3 | 67 |
| Comparative | 16.7 | 71.3 | 12.0 | 16.9 | 70.6 | 11.9 | 19.3 | 492.0 | 0 |
| example 4-1 | | | | | | | | | |
| Comparative | 18.5 | 69.5 | 12.0 | 18.7 | 68.8 | 11.9 | 21.4 | 511.1 | 3 |
| example 4-2 | | | | | | | | | |
| Comparative | 22.0 | 66.0 | 12.0 | 22.2 | 65.3 | 11.9 | 25.4 | 552.9 | 40 |
| example 4-3 | | | | | | | | | |
| Comparative | 43.1 | 44.9 | 12.0 | 43.4 | 44.4 | 11.9 | 49.4 | 385.0 | 69 |
| example 4-4 | | | | | | | | | |
| Comparative | 44.0 | 44.0 | 12.0 | 44.3 | 43.6 | 11.9 | 50.4 | 359.7 | 70 |
| example 4-5 | | | | | | | | | |

As Comparative examples 4-1 to 4-5 relative to Examples 4-1 to 4-8, anode active materials and secondary batteries were formed in the same manner as in Examples 4-1 to 4-8, except that the Fe/(Sn+Fe) ratio was changed as shown in Table 4. The Fe/(Sn+Fe) ratios in Comparative examples 4-1 to 4-5 were 19 wt %, 21 wt %, 25 wt %, 59 wt %, or 50 wt %, respectively.

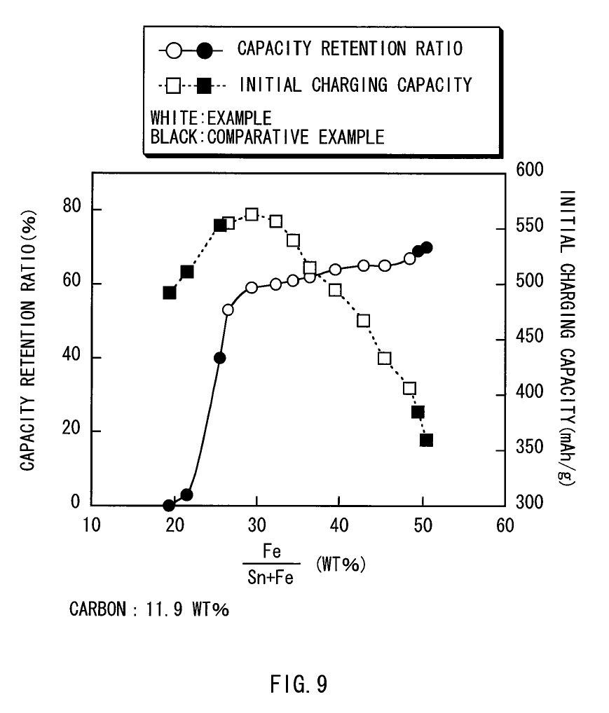

For the anode active materials of Examples 4-1 to 4-8 and Comparative examples 4-1 to 4-5, composition analysis was performed in the same manner as in Examples 1-1 to 1-10. The results are shown in Table 4. Further, when XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element. Further, for the secondary batteries, the initial charging capacity and the cycle characteristics were similarly measured. The results are shown in Table 4 and FIG. 9.

As evidenced by Table 4 and FIG. 9, according to Examples 1-1 and 4-1 to 4-8, in which the Fe/(Sn+Fe) ratio of the synthesized anode active material was from 26.4 wt % to 48.4 wt %, both the capacity retention ratio and the initial charging capacity could be improved than in Comparative examples 4-1 to 4-5 in which the Fe/(Sn+Fe) ratio was out of the foregoing range. In particular, in Examples 1-1 and 4-2 to 4-7, in which the Fe/(Sn+Fe) ratio was from 29.3 wt % to 45.4 wt %, higher values were obtained.

That is, it was found that when the Fe/(Sn+Fe) ratio in the anode active material was from 26.4 wt % to 48.4 wt %, more preferably from 29.3 wt % to 45.4 wt %, the capacity and the cycle characteristics could be improved even when the carbon content was 11.9 wt %.

### Examples 5-1 to 5-14

Anode active materials and secondary batteries were formed in the same manner as in Example 1-5, except that silicon powder was further used as a raw material, and the raw material ratio among tin, iron, carbon, and silicon was changed as shown in Table 5. Specifically, the raw material ratio of the silicon powder was changed in the range from 0.2 wt % to 10.0 wt %, and the Fe/(Sn+Fe) ratio was 32.0 wt %. For the anode active materials of Examples 5-1 to 5-14, composition analysis was performed in the same manner as in Examples 1-1 to 1-10. The results are shown in Table 5. Silicon contents were measured by ICP optical emission spectrometry. Further, when XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element. Further, for the secondary batteries, the initial charging capacity and the cycle characteristics were similarly measured. The results are shown in Table 5.

TABLE 5

| | | | | | | | | | Initial | |
|---|---|---|---|---|---|---|---|---|---|---|
| | Raw material ratio | | | | Analytical value | | | | charging | Capacity |
| | (wt %) | | | | (wt %) | | | | capacity | retention |
| | Fe | Sn | C | Si | Fe | Sn | C | Si | (mAh/g) | ratio (%) |
| Example 1-5 | 25.6 | 54.4 | 20.0 | 0 | 25.8 | 54.0 | 19.8 | 0 | 644.2 | 85 |
| Example 5-1 | 25.5 | 54.3 | 20.0 | 0.2 | 25.8 | 53.8 | 19.8 | 0.2 | 644.9 | 85 |
| Example 5-2 | 25.5 | 54.1 | 20.0 | 0.4 | 25.7 | 53.7 | 19.8 | 0.4 | 645.3 | 85 |
| Example 5-3 | 25.4 | 54.1 | 20.0 | 0.5 | 25.7 | 53.6 | 19.8 | 0.5 | 648.6 | 84 |
| Example 5-4 | 25.3 | 53.9 | 20.0 | 0.8 | 25.6 | 53.4 | 19.8 | 0.8 | 656.7 | 84 |
| Example 5-5 | 25.3 | 53.7 | 20.0 | 1.0 | 25.6 | 53.3 | 19.8 | 1.0 | 662.3 | 83 |
| Example 5-6 | 25.0 | 53.0 | 20.0 | 2.0 | 25.3 | 52.7 | 19.8 | 2.0 | 680.0 | 81 |
| Example 5-7 | 24.6 | 52.4 | 20.0 | 3.0 | 24.9 | 51.9 | 19.8 | 3.0 | 692.1 | 79 |
| Example 5-8 | 24.3 | 51.7 | 20.0 | 4.0 | 24.6 | 51.3 | 19.8 | 4.0 | 700.6 | 76 |
| Example 5-9 | 24.0 | 51.0 | 20.0 | 5.0 | 24.3 | 50.6 | 19.8 | 5.0 | 710.3 | 73 |
| Example 5-10 | 23.7 | 50.3 | 20.0 | 6.0 | 24.0 | 50.0 | 19.8 | 5.9 | 716.5 | 71 |
| Example 5-11 | 23.4 | 49.6 | 20.0 | 7.0 | 23.7 | 49.4 | 19.8 | 6.9 | 721.3 | 68 |
| Example 5-12 | 23.0 | 49.0 | 20.0 | 8.0 | 23.3 | 48.5 | 19.8 | 7.9 | 725.1 | 62 |
| Example 5-13 | 22.7 | 48.3 | 20.0 | 9.0 | 23.0 | 47.9 | 19.8 | 8.9 | 729.7 | 46 |
| Example 5-14 | 22.4 | 47.6 | 20.0 | 10.0 | 22.7 | 47.3 | 19.8 | 9.9 | 732.2 | 8 |

As evidenced by Table 5, according to Examples 5-1 to 5-14 containing silicon, the initial charging capacity could be improved than in Example 1-5 not containing silicon. However, there was a tendency that as the silicon content became large, the capacity retention ratio was lowered.

That is, it was found that when silicon was contained in the anode active material, the capacity could be improved, and the silicon content was preferably in the range from 0.5 wt % to 7.9 wt %.

### Examples 6-1 to 6-18

In Examples 6-1 to 6-16, anode active materials were synthesized and secondary batteries were fabricated in the same manner as in Example 1-5, except that for the raw material, at least one from the group consisting of aluminum powder, titanium powder, vanadium powder, chromium powder, niobium powder, and tantalum powder was used as a first element, at least one from the group consisting of cobalt powder, nickel powder, copper powder, zinc powder, gallium powder, and indium powder was used as a second element, and the raw material ratio among tin, iron, carbon, the first element, and the second element was set as shown in Table 6. Further, in Example 6-17, an anode active material was synthesized and a secondary battery was fabricated in the same manner as in Example 1-5, except that for the raw material, titanium powder was prepared as a first element, and the raw material ratio among tin, iron, carbon, and titanium was set as shown in Table 6. Further, in Example 6-18, an anode active material was synthesized and a secondary battery was fabricated in the same manner as in Example 1-5, except that for the raw material, zinc powder was prepared as a second element, and the raw material ratio among tin, iron, carbon, and zinc was set as shown in Table 6. For the anode active materials, composition analysis was performed in the same manner as in Examples 1-1 to 1-10. The results are shown in Table 6. Contents of aluminum, titanium, vanadium, chromium, niobium, tantalum, cobalt, nickel, copper, zinc, gallium, and indium were measured by ICP optical emission spectrometry. Further, when XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element. Further, for the secondary batteries, the initial charging capacity and the cycle characteristics were similarly measured. The results are shown in Table 6.

TABLE 6

| | Raw material ratio | | | | | | | Analytical value | | | | | | | Initial | |
|---|---|---|---|---|---|---|---|---|---|---|---|---|---|---|---|---|
| | | | | 1st | | 2nd | | | | | 1st | | 2nd | | charging | Capacity |
| | Fe | Sn | C | element | | element | | Fe | Sn | C | element | | element | | capacity | retention |
| | (wt %) | (wt %) | (wt %) | Kind | wt % | Kind | wt % | (wt %) | (wt %) | (wt %) | Kind | wt % | Kind | wt % | (mAh/g) | ratio (%) |
| Example | 25.6 | 54.4 | 20.0 | — | — | — | — | 25.8 | 54.0 | 19.8 | — | — | — | — | 644.2 | 85 |
| 1-5 | | | | | | | | | | | | | | | | |
| Example | 23.8 | 50.6 | 18.6 | Al | 2.0 | Zn | 5.0 | 24.1 | 50.2 | 18.4 | Al | 2.0 | Zn | 5.0 | 638.1 | 89 |
| 6-1 | | | | | | | | | | | | | | | | |
| Example | 23.6 | 50.0 | 18.4 | Ti | 3.0 | Zn | 5.0 | 23.8 | 49.7 | 18.2 | Ti | 3.0 | Zn | 5.0 | 637.7 | 90 |
| 6-2 | | | | | | | | | | | | | | | | |
| Example | 23.8 | 50.6 | 18.6 | V | 2.0 | Zn | 5.0 | 24.1 | 50.2 | 18.4 | V | 2.0 | Zn | 5.0 | 638.5 | 88 |
| 6-3 | | | | | | | | | | | | | | | | |
| Example | 23.6 | 50.0 | 18.4 | Cr | 3.0 | Zn | 5.0 | 23.8 | 49.7 | 18.2 | Cr | 3.0 | Zn | 5.0 | 636.8 | 88 |
| 6-4 | | | | | | | | | | | | | | | | |
| Example | 23.6 | 50.0 | 18.4 | Nb | 3.0 | Zn | 5.0 | 23.8 | 49.7 | 18.2 | Nb | 3.0 | Zn | 5.0 | 636.5 | 87 |
| 6-5 | | | | | | | | | | | | | | | | |
| Example | 23.8 | 50.6 | 18.6 | Ta | 2.0 | Zn | 5.0 | 24.1 | 50.2 | 18.4 | Ta | 2.0 | Zn | 5.0 | 638.0 | 88 |
| 6-6 | | | | | | | | | | | | | | | | |
| Example | 21.7 | 46.2 | 17.0 | Al | 0.1 | Co | 15.0 | 21.9 | 45.7 | 16.8 | Al | 0.1 | Co | 14.9 | 629.8 | 92 |
| 6-7 | | | | | | | | | | | | | | | | |
| Example | 22.9 | 48.7 | 17.9 | Al | 10.0 | Ni | 0.5 | 23.1 | 48.2 | 17.7 | Al | 9.9 | Ni | 0.5 | 631.6 | 90 |
| 6-8 | | | | | | | | | | | | | | | | |
| Example | 24.0 | 51.1 | 18.8 | Ti | 0.1 | Cu | 6.0 | 24.2 | 50.7 | 18.6 | Ti | 0.1 | Cu | 6.0 | 640.3 | 87 |
| 6-9 | | | | | | | | | | | | | | | | |
| Example | 22.3 | 47.3 | 17.4 | Ti | 10.0 | Ga | 3.0 | 22.5 | 46.9 | 17.2 | Ti | 9.9 | Ga | 3.0 | 630.5 | 88 |
| 6-10 | | | | | | | | | | | | | | | | |
| Example | 25.4 | 54.1 | 19.9 | Cr | 0.1 | In | 0.5 | 25.7 | 53.6 | 19.7 | Cr | 0.1 | In | 0.5 | 643.8 | 87 |
| 6-11 | | | | | | | | | | | | | | | | |
| Example | 22.9 | 48.7 | 17.9 | Cr | 10.0 | In | 0.5 | 23.1 | 48.2 | 17.7 | Cr | 9.9 | In | 0.5 | 632.0 | 88 |
| 6-12 | | | | | | | | | | | | | | | | |
| Example | 24.3 | 51.6 | 19.0 | Nb | 0.1 | Cu | 4.0 | 24.6 | 51.3 | 18.8 | Nb | 0.1 | Cu | 4.0 | 640.9 | 88 |
| 6-13 | | | | Ta | 0.5 | Zn | 0.5 | | | | Ta | 0.5 | Zn | 0.5 | | |
| Example | 22.9 | 48.7 | 17.9 | Nb | 10.0 | Co | 0.5 | 23.1 | 48.2 | 17.7 | Nb | 9.9 | Co | 0.5 | 632.2 | 89 |
| 6-14 | | | | | | | | | | | | | | | | |
| Example | 20.7 | 44.1 | 16.2 | Cr | 3.0 | Zn | 16.0 | 20.9 | 43.7 | 16.0 | Cr | 3.0 | Zn | 15.9 | 608.2 | 91 |
| 6-15 | | | | | | | | | | | | | | | | |
| Example | 18.4 | 39.2 | 14.4 | Al | 12.0 | Cu | 16.0 | 18.6 | 38.8 | 14.3 | Al | 11.9 | Cu | 15.9 | 562.1 | 93 |
| 6-16 | | | | | | | | | | | | | | | | |
| Example | 24.6 | 52.2 | 19.2 | Ti | 4.0 | — | — | 24.8 | 51.8 | 19.0 | Ti | 4.0 | — | — | 641.3 | 85 |
| 6-17 | | | | | | | | | | | | | | | | |
| Example | 24.3 | 51.7 | 19.0 | — | — | Zn | 5.0 | 24.6 | 51.3 | 18.8 | — | — | Zn | 5.0 | 640.7 | 85 |
| 6-18 | | | | | | | | | | | | | | | | |

As evidenced by Table 6, according to Examples 6-1 to 6-16 containing the first element and the second element, the capacity retention ratio could be improved than in Example 1-5 not containing the first element and the second element, Example 6-17 containing only the first element, Example 6-18 containing only the second element.

Further, according to Examples 6-1 to 6-14, in which the first element content was from 0.1 wt % to 9.9 wt % and the second element content was from 0.5 wt % to 14.9 wt %, high values could be obtained for the initial charging capacity as well.

That is, it was found that when at least one from the group consisting of aluminum, titanium, vanadium, chromium, niobium, and tantalum, and at least one from the group consisting of cobalt, nickel, copper, zinc, gallium, and indium was contained in the anode active material, cycle characteristics could be more improved, and it was found that when the contents thereof were from 0.1 wt % to 9.9 wt % and from 0.5 wt % to 14.9 wt %, respectively, a high capacity could be obtained.

### Examples 7-1 to 7-19

Secondary batteries were fabricated in the same manner as in Example 1-5, except that two or more of 4-fluoro-1,3-dioxolane-2-one (FEC) as a cyclic carbonate having halogen atom, ethylene carbonate (EC), propylene carbonate (PC), and dimethyl carbonate (DMC) were used as a solvent, and the 4-fluoro-1,3-dioxolane-2-one content was changed in the range from 0 wt % to 80.0 wt %. Specific composition of each solvent was as shown in Table 7.

TABLE 7

| | Raw material ratio | | | Analytical value | | | Solvent | | | | Capacity |
|---|---|---|---|---|---|---|---|---|---|---|---|
| | (wt %) | | | (wt %) | | | (wt %) | | | | retention |
| | Fe | Sn | C | Fe | Sn | C | FEC | EC | PC | DMC | ratio (%) |
| Example 7-1 | 25.6 | 54.4 | 20.0 | 25.9 | 54.0 | 19.8 | 0 | 30.0 | 10.0 | 60.0 | 77 |
| Example 7-2 | 25.6 | 54.4 | 20.0 | 25.9 | 54.0 | 19.8 | 0.1 | 29.9 | 10.0 | 60.0 | 78 |
| Example 7-3 | 25.6 | 54.4 | 20.0 | 25.9 | 54.0 | 19.8 | 0.5 | 29.5 | 10.0 | 60.0 | 80 |
| Example 7-4 | 25.6 | 54.4 | 20.0 | 25.9 | 54.0 | 19.8 | 1.0 | 29.0 | 10.0 | 60.0 | 82 |
| Example 7-5 | 25.6 | 54.4 | 20.0 | 25.9 | 54.0 | 19.8 | 5.0 | 25.0 | 10.0 | 60.0 | 85 |
| Example 7-6 | 25.6 | 54.4 | 20.0 | 25.9 | 54.0 | 19.8 | 10.0 | 20.0 | 10.0 | 60.0 | 86 |
| Example 7-7 | 25.6 | 54.4 | 20.0 | 25.9 | 54.0 | 19.8 | 15.0 | 15.0 | 10.0 | 60.0 | 86 |
| Example 7-8 | 25.6 | 54.4 | 20.0 | 25.9 | 54.0 | 19.8 | 20.0 | 10.0 | 10.0 | 60.0 | 86 |
| Example 7-9 | 25.6 | 54.4 | 20.0 | 25.9 | 54.0 | 19.8 | 20.0 | 20.0 | 0 | 60.0 | 86 |
| Example 7-10 | 25.6 | 54.4 | 20.0 | 25.9 | 54.0 | 19.8 | 25.0 | 5.0 | 10.0 | 60.0 | 87 |
| Example 7-11 | 25.6 | 54.4 | 20.0 | 25.9 | 54.0 | 19.8 | 30.0 | 0 | 10.0 | 60.0 | 87 |
| Example 7-12 | 25.6 | 54.4 | 20.0 | 25.9 | 54.0 | 19.8 | 30.0 | 10.0 | 0 | 60.0 | 88 |
| Example 7-13 | 25.6 | 54.4 | 20.0 | 25.9 | 54.0 | 19.8 | 35.0 | 0 | 5.0 | 60.0 | 88 |
| Example 7-14 | 25.6 | 54.4 | 20.0 | 25.9 | 54.0 | 19.8 | 40.0 | 0 | 0 | 60.0 | 89 |
| Example 7-15 | 25.6 | 54.4 | 20.0 | 25.9 | 54.0 | 19.8 | 50.0 | 0 | 0 | 50.0 | 88 |
| Example 7-16 | 25.6 | 54.4 | 20.0 | 25.9 | 54.0 | 19.8 | 60.0 | 0 | 0 | 40.0 | 86 |
| Example 7-17 | 25.6 | 54.4 | 20.0 | 25.9 | 54.0 | 19.8 | 65.0 | 0 | 0 | 35.0 | 83 |
| Example 7-18 | 25.6 | 54.4 | 20.0 | 25.9 | 54.0 | 19.8 | 70.0 | 0 | 0 | 30.0 | 82 |
| Example 7-19 | 25.6 | 54.4 | 20.0 | 25.9 | 54.0 | 19.8 | 80.0 | 0 | 0 | 20.0 | 81 |

EC: Ethylene carbonate
PC: Propylene carbonate
DMC: Dimethyl carbonate
FEC: 4-fluoro-1,3-dioxolane-2-one

For the secondary batteries of Examples 7-1 to 7-19, the cycle characteristics were examined in the same manner as in Examples 1-1 to 1-10. The results are shown in Table 7.

As evidenced by Table 7, as the 4-fluoro-1,3-dioxolane-2-one content was improved, the capacity retention ratio became large, showed the maximum value, and then decreased.

That is, it was found that when the cyclic carbonate derivative having halogen atom was contained, cycle characteristics could be improved.

### Examples 8-1 to 8-8, 9-1

Secondary batteries were fabricated in the same manner as in Example 1-5, except that 1,3,2-dioxathiolane-2-oxide (ES) as a cyclic sulfur compound, 4-fluoro-1,3-dioxolane-2-one as a cyclic carbonate having halogen atom, ethylene carbonate, propylene carbonate, and dimethyl carbonate were used as a solvent, and the 1,3,2-dioxathiolane-2-oxide content in the solvent was changed in the range from 0.1 wt % to 10.0 wt %. Specific composition of each solvent was as shown in Table 8.

TABLE 8

| | Raw material ratio | | | Analytical value | | | Solvent | | | | | Capacity |
|---|---|---|---|---|---|---|---|---|---|---|---|---|
| | (wt %) | | | (wt %) | | | (wt %) | | | | | retention |
| | Fe | Sn | C | Fe | Sn | C | ES | FEC | EC | PC | DMC | ratio (%) |
| Example 7-6 | 25.6 | 54.4 | 20.0 | 25.9 | 54.0 | 19.8 | 0 | 10.0 | 20.0 | 10.0 | 60.0 | 86 |
| Example 8-1 | 25.6 | 54.4 | 20.0 | 25.9 | 54.0 | 19.8 | 0.1 | 10.0 | 20.0 | 10.0 | 59.9 | 87 |
| Example 8-2 | 25.6 | 54.4 | 20.0 | 25.9 | 54.0 | 19.8 | 0.5 | 10.0 | 20.0 | 10.0 | 59.5 | 88 |
| Example 8-3 | 25.6 | 54.4 | 20.0 | 25.9 | 54.0 | 19.8 | 1.0 | 10.0 | 20.0 | 10.0 | 59.0 | 89 |
| Example 8-4 | 25.6 | 54.4 | 20.0 | 25.9 | 54.0 | 19.8 | 2.0 | 10.0 | 20.0 | 10.0 | 58.0 | 91 |
| Example 8-5 | 25.6 | 54.4 | 20.0 | 25.9 | 54.0 | 19.8 | 3.0 | 10.0 | 20.0 | 10.0 | 57.0 | 92 |
| Example 8-6 | 25.6 | 54.4 | 20.0 | 25.9 | 54.0 | 19.8 | 5.0 | 10.0 | 20.0 | 10.0 | 55.0 | 92 |
| Example 8-7 | 25.6 | 54.4 | 20.0 | 25.9 | 54.0 | 19.8 | 7.5 | 10.0 | 20.0 | 10.0 | 52.5 | 90 |
| Example 8-8 | 25.6 | 54.4 | 20.0 | 25.9 | 54.0 | 19.8 | 10.0 | 10.0 | 20.0 | 10.0 | 40.0 | 87 |
| Comparative | 25.6 | 54.4 | 20.0 | 25.9 | 54.0 | 19.8 | 0 | 0 | 30.0 | 10.0 | 60.0 | 77 |
| example 7-1 | | | | | | | | | | | | |
| Comparative | 25.6 | 54.4 | 20.0 | 25.9 | 54.0 | 19.8 | 3.0 | 0 | 27.0 | 10.0 | 60.0 | 77 |
| example 9-1 | | | | | | | | | | | | |

EC: Ethylene carbonate
PC: Propylene carbonate
DMC: Dimethyl carbonate
FEC: 4-fluoro-1,3-dioxolane-2-one
ES: 1,3,2-dioxathiolane-2-oxide

In Example 9-1, a secondary battery was fabricated in the same manner as in Example 1-5, except that 1,3,2-dioxathiolane-2-oxide as a cyclic sulfur compound, ethylene carbonate, propylene carbonate, and dimethyl carbonate were used as a solvent. The 1,3,2-dioxathiolane-2-oxide content in the solvent was 3.0 wt %, and the contents of the other solvents were as shown in FIG. 8.

For the secondary batteries of Examples 8-1 to 8-8 and 9-1, the cycle characteristics were examined in the same manner as in Examples 1-1 to 1-10. The results are shown in Table 8 together with the results of Examples 7-1 and 7-6.

As evidenced by Table 8, in Examples 7-6 and 8-1 to 8-8 using 4-fluoro-1,3-dioxolane-2-one, as the 1,3,2-dioxathiolane-2-oxide content was improved, the capacity retention ratio became large, showed the maximum value, and then decreased. Meanwhile, in Examples 7-1 and 9-1 not using 4-fluoro-1,3-dioxolane-2-one, effect of improving the capacity retention ratio by using 1,3,2-dioxathiolane-2-oxide was not shown.

That is, it was found that when the cyclic sulfur compound was contained in addition to the cyclic carbonate derivative having halogen atom, cycle characteristics could be more improved, and it was found that the cyclic sulfur compound content in the solvent was preferably from 0.1 wt % to 10 wt %.

### Examples 10-1 to 10-10

As raw materials, tin powder, iron powder, silver powder, and carbon powder were prepared. Tin powder, iron powder, and silver powder were alloyed to form tin-iron-silver alloy powder, to which carbon powder was added and dry-blended. For the raw material ratio, as shown in Table 9, the iron ratio to the total of tin and iron was constantly maintained at 32 wt %, the raw material ratio of silver was constantly maintained at 3.0 wt %, and the raw material ratio of carbon was changed in the range from 12 wt % to 30 wt %. Subsequently, 20 g of the mixture and about 400 g of corundum being 9 mm in diameter were set in the reaction vessel of a planetary ball mill of Ito Seisakusho Co., Ltd. Next, inside of the reaction vessel was substituted with the argon atmosphere. Then, 10 minute operation at 250 rpm and 10 minute recess were repeated until the total operation time became 30 hours. After that, the reaction vessel was cooled down to room temperatures and the synthesized anode active material powder was taken out. Coarse grains were removed through a 280-mesh sieve.

TABLE 9

| | | | | | | | | | Initial | |
|---|---|---|---|---|---|---|---|---|---|---|
| | Raw material ratio | | | | Analytical value | | | | charging | Capacity |
| | (wt %) | | | | (wt %) | | | | capacity | retention |
| | Fe | Sn | Ag | C | Fe | Sn | Ag | C | (mAh/g) | ratio (%) |
| Example 10-1 | 27.2 | 57.8 | 3.0 | 12.0 | 27.5 | 57.4 | 3.0 | 11.9 | 553.3 | 65 |
| Example 10-2 | 26.6 | 56.4 | 3.0 | 14.0 | 26.9 | 56.0 | 3.0 | 13.9 | 578.3 | 79 |
| Example 10-3 | 25.9 | 55.1 | 3.0 | 16.0 | 26.2 | 54.7 | 3.0 | 15.8 | 594.7 | 86 |
| Example 10-4 | 25.3 | 53.7 | 3.0 | 18.0 | 25.6 | 53.3 | 3.0 | 17.8 | 630.2 | 88 |
| Example 10-5 | 24.6 | 52.4 | 3.0 | 20.0 | 24.9 | 52.0 | 3.0 | 19.8 | 640.3 | 90 |
| Example 10-6 | 24.0 | 51.0 | 3.0 | 22.0 | 24.3 | 50.6 | 3.0 | 21.8 | 643.2 | 89 |
| Example 10-7 | 23.4 | 49.6 | 3.0 | 24.0 | 23.7 | 49.3 | 3.0 | 23.8 | 638.4 | 87 |
| Example 10-8 | 22.7 | 48.3 | 3.0 | 26.0 | 23.0 | 48.0 | 3.0 | 25.7 | 625.8 | 85 |
| Example 10-9 | 22.1 | 46.9 | 3.0 | 28.0 | 22.4 | 46.6 | 3.0 | 27.7 | 608.8 | 80 |
| Example 10-10 | 21.4 | 45.6 | 3.0 | 30.0 | 21.7 | 45.3 | 3.0 | 29.7 | 594.8 | 68 |
| Comparative | 31.0 | 66.0 | 3.0 | 0 | 31.3 | 65.5 | 3.0 | 0 | 121.7 | 5 |
| example 10-1 | | | | | | | | | | |
| Comparative | 29.1 | 61.9 | 3.0 | 6.0 | 29.4 | 61.5 | 3.0 | 5.9 | 475.8 | 11 |
| example 10-2 | | | | | | | | | | |
| Comparative | 27.8 | 59.2 | 3.0 | 10.0 | 28.1 | 58.8 | 3.0 | 9.9 | 538.4 | 34 |
| example 10-3 | | | | | | | | | | |
| Comparative | 20.8 | 44.2 | 3.0 | 32.0 | 21.1 | 44.0 | 3.0 | 31.7 | 575.1 | 49 |
| example 10-4 | | | | | | | | | | |
| Comparative | 18.2 | 38.8 | 3.0 | 40.0 | 18.5 | 38.7 | 3.0 | 39.6 | 367.1 | 30 |
| example 10-5 | | | | | | | | | | |

For the obtained anode active material, the composition was analyzed in the same manner as in Examples 1-1 to 1-10. The silver content was measured by ICP optical emission spectroscopy. The analytic values are shown in Table 9. Further, when XPS was performed, Peak P1 was obtained. When the obtained peak was analyzed, Peak P2 of surface contamination carbon and Peak P3 of C1s in the anode active material were obtained similarly to in Examples 1-1 to 1-10. For all cases, Peak P3 was obtained in the region lower than 284.5 eV. That is, it was confirmed that carbon in the anode active material was bonded to other element.

As Comparative example 10-1 relative to Examples 10-1 to 10-10, an anode active material was synthesized in the same manner as in Examples 10-1 to 10-10, except that the carbon powder was not used as a raw material. As Comparative examples 10-2 to 10-5, anode active materials were synthesized in the same manner as in Examples 10-1 to 10-10, except that the raw material ratio of carbon powder was changed as shown in Table 9. For the anode active materials of Comparative examples 10-1 to 10-5, the composition was analyzed in the same manner as in Examples 1-1 to 1-10. The results are shown in Table 9. Further, when XPS was performed, Peak P1 was obtained in Comparative examples 10-2 to 10-5. When Peak P1 was analyzed, Peak P2 of surface contamination carbon and Peak P3 of C1s in the anode active material were obtained similarly to in Examples 10-1 to 10-10. Peak P3 was obtained in the region lower than 284.5 eV for all cases. That is, it was confirmed that at least part of carbon contained in the anode active material was bonded to other element. Meanwhile, in Comparative example 10-1, Peak P4 was obtained. When peak was analyzed, only Peak P2 of surface contamination carbon was obtained.

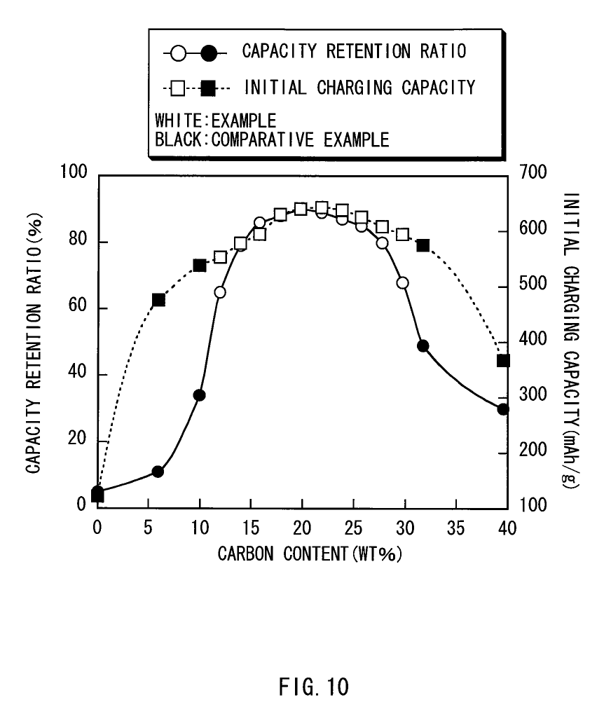

Next, secondary batteries were fabricated by using the anode active material powders of Examples 10-1 to 10-10 and Comparative examples 10-1 to 10-5 in the same manner as in Examples 1-1 to 1-10, and the initial charging capacity and the cycle characteristics were similarly measured. The results are shown in Table 9 and FIG. 10.

As evidenced by Table 9 and FIG. 10, according to Examples 10-1 to 10-10, in which the carbon content in the anode active material was from 11.9 wt % to 29.7 wt %, the capacity retention ratio could be significantly improved than in Comparative examples 10-1 to 10-5 in which the carbon content was out of the range. Further, according to Examples 10-1 to 10-10, the initial charging capacity could be improved as well.

Further, when the carbon content in the anode active material was in the range from 13.9 wt % to 27.7 wt %, in particular in the range from 15.8 wt % to 23.8 wt %, higher values could be obtained.

That is, it was found that when the carbon content was in the range from 11.9 wt % to 29.7 wt %, more preferably in the range from 13.9 wt % to 27.7 wt %, and much more preferably in the range from 15.8 wt % to 23.8 wt %, the capacity and the cycle characteristics could be improved as well even if silver was contained in the anode active material.

### Examples 11-1 to 11-8

Anode active materials were synthesized in the same manner as in Examples 10-1 to 10-10, except that the raw material ratio among tin, iron, silver, and carbon was changed as shown in Table 10. Specifically, the raw material ratio of silver was constantly maintained at 3.0 wt %, the raw material ratio of carbon was constantly maintained at 30.0 wt %, and the Fe/(Sn+Fe) ratio was changed in the range from 26 wt % to 48 wt %.

TABLE 10

| | | | | | | | | | | Initial | |
|---|---|---|---|---|---|---|---|---|---|---|---|
| | Raw material ratio | | | | Analytical value | | | | | charging | Capacity |
| | (wt %) | | | | (wt %) | | | | | capacity | retention |
| | Fe | Sn | Ag | C | Fe | Sn | Ag | C | Fe/(Sn + Fe) | (mAh/g) | ratio (%) |
| Example 11-1 | 17.4 | 49.6 | 3.0 | 30.0 | 17.7 | 49.3 | 3.0 | 29.7 | 26.4 | 593.1 | 60 |
| Example 11-2 | 19.4 | 47.6 | 3.0 | 30.0 | 19.7 | 47.3 | 3.0 | 29.7 | 29.4 | 601.7 | 66 |
| Example 10-10 | 21.4 | 45.6 | 3.0 | 30.0 | 21.7 | 45.3 | 3.0 | 29.7 | 32.4 | 594.8 | 68 |
| Example 11-3 | 22.8 | 44.2 | 3.0 | 30.0 | 23.1 | 43.9 | 3.0 | 29.7 | 34.5 | 576.7 | 70 |
| Example 11-4 | 24.1 | 42.9 | 3.0 | 30.0 | 24.4 | 42.6 | 3.0 | 29.7 | 36.4 | 550.5 | 71 |
| Example 11-5 | 26.1 | 40.9 | 3.0 | 30.0 | 26.4 | 40.6 | 3.0 | 29.7 | 39.4 | 528.8 | 72 |
| Example 11-6 | 28.1 | 38.9 | 3.0 | 30.0 | 28.4 | 38.6 | 3.0 | 29.7 | 42.4 | 499.1 | 74 |
| Example 11-7 | 30.2 | 36.9 | 3.0 | 30.0 | 30.5 | 36.6 | 3.0 | 29.7 | 45.5 | 463.2 | 78 |
| Example 11-8 | 32.2 | 34.8 | 3.0 | 30.0 | 32.5 | 34.5 | 3.0 | 29.7 | 48.5 | 434.4 | 81 |
| Comparative | 12.7 | 54.3 | 3.0 | 30.0 | 13.0 | 54.0 | 3.0 | 29.7 | 19.4 | 525.8 | 6 |
| example 11-1 | | | | | | | | | | | |
| Comparative | 14.1 | 52.9 | 3.0 | 30.0 | 14.4 | 52.6 | 3.0 | 29.7 | 21.5 | 546.3 | 12 |
| example 11-2 | | | | | | | | | | | |
| Comparative | 16.8 | 50.3 | 3.0 | 30.0 | 17.1 | 50.0 | 3.0 | 29.7 | 25.5 | 590.9 | 49 |
| example 11-3 | | | | | | | | | | | |
| Comparative | 32.8 | 34.2 | 3.0 | 30.0 | 33.1 | 33.9 | 3.0 | 29.7 | 49.4 | 411.5 | 83 |
| example 11-4 | | | | | | | | | | | |
| Comparative | 33.5 | 33.5 | 3.0 | 30.0 | 33.8 | 33.2 | 3.0 | 29.7 | 50.4 | 374.4 | 85 |
| example 11-5 | | | | | | | | | | | |

As Comparative examples 11-1 to 11-5 relative to Examples 11-1 to 11-8, anode active materials were synthesized in the same manner as in Examples 11-1 to 11-10, except that the Fe/(Sn+Fe) ratio was changed as shown in Table 10. The Fe/(Sn+Fe) ratios in Comparative examples 11-1 to 11-5 were 19 wt %, 21 wt %, 25 wt %, 49 wt %, or 50 wt %, respectively.

For the obtained anode active materials of Examples 11-1 to 11-8 and Comparative examples 11-1 to 11-5, when XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element.

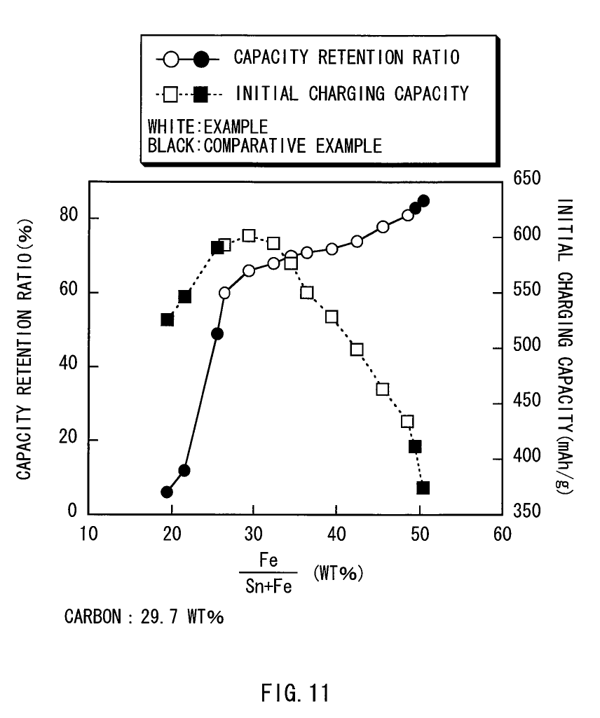

Next, the secondary batteries were fabricated by using the anode active material powders of Examples 11-1 to 11-8 and Comparative examples 11-1 to 11-5 in the same manner as in Examples 1-1 to 1-10, and the initial charging capacity and the cycle characteristics were similarly measured. The results are shown in Table 10 and FIG. 11.

As evidenced by Table 10 and FIG. 11, according to Examples 10-10 and 11-1 to 11-8, in which the Fe/(Sn+Fe) ratio of the synthesized anode active material was from 26.4 wt % to 48.5 wt %, both the capacity retention ratio and the initial charging capacity could be improved than in Comparative examples 11-1 to 11-5 in which the Fe/(Sn+Fe) ratio was out of the foregoing range. In particular, in Examples 10-10 and 11-2 to 11-7, in which the Fe/(Sn+Fe) ratio was from 29.4 wt % to 45.4 wt %, higher values were obtained.

That is, it was found that when the Fe/(Sn+Fe) ratio in the anode active material was from 26.4 wt % to 48.5 wt %, more preferably from 29.4 wt % to 45.5 wt %, the capacity and the cycle characteristics could be improved as well even if silver was contained in the anode active material.

### Examples 12-1 to 12-8

Anode active materials were synthesized in the same manner as in Examples 10-1 to 10-10, except that the raw material ratio among tin, iron, silver, and carbon was changed as shown in Table 11. Specifically, the raw material ratio of silver was constantly maintained at 3.0 wt %, the raw material ratio of carbon was constantly maintained at 20.0 wt %, and the Fe/(Sn+Fe) ratio was changed in the range from 26 wt % to 48 wt %.

TABLE 11

| | | | | | | | | | | Initial | |
|---|---|---|---|---|---|---|---|---|---|---|---|
| | Raw material ratio | | | | Analytical value | | | | | charging | Capacity |
| | (wt %) | | | | (wt %) | | | | | capacity | retention |
| | Fe | Sn | Ag | C | Fe | Sn | Ag | C | Fe/(Sn + Fe) | (mAh/g) | ratio (%) |
| Example 12-1 | 20.0 | 57.0 | 3.0 | 20.0 | 20.3 | 56.6 | 3.0 | 19.8 | 26.4 | 638.4 | 81 |
| Example 12-2 | 22.3 | 54.7 | 3.0 | 20.0 | 22.6 | 54.3 | 3.0 | 19.8 | 29.4 | 647.7 | 87 |
| Example 10-5 | 24.6 | 52.4 | 3.0 | 20.0 | 24.9 | 52.0 | 3.0 | 19.8 | 32.4 | 640.3 | 90 |
| Example 12-3 | 26.2 | 50.8 | 3.0 | 20.0 | 26.5 | 50.4 | 3.0 | 19.8 | 34.5 | 620.8 | 90 |
| Example 12-4 | 27.7 | 49.3 | 3.0 | 20.0 | 28.0 | 48.9 | 3.0 | 19.8 | 36.4 | 592.5 | 91 |
| Example 12-5 | 30.0 | 47.0 | 3.0 | 20.0 | 30.3 | 46.6 | 3.0 | 19.8 | 39.4 | 569.3 | 92 |
| Example 12-6 | 32.3 | 44.7 | 3.0 | 20.0 | 32.6 | 44.3 | 3.0 | 19.8 | 42.4 | 537.3 | 92 |
| Example 12-7 | 34.7 | 42.4 | 3.0 | 20.0 | 35.0 | 42.0 | 3.0 | 19.8 | 45.5 | 498.6 | 93 |
| Example 12-8 | 37.0 | 40.0 | 3.0 | 20.0 | 37.3 | 39.7 | 3.0 | 19.8 | 48.4 | 467.5 | 93 |
| Comparative | 14.6 | 62.4 | 3.0 | 20.0 | 14.9 | 61.9 | 3.0 | 19.8 | 19.4 | 566.0 | 9 |
| example 12-1 | | | | | | | | | | | |
| Comparative | 16.2 | 60.8 | 3.0 | 20.0 | 16.5 | 60.4 | 3.0 | 19.8 | 21.5 | 588.1 | 37 |
| example 12-2 | | | | | | | | | | | |
| Comparative | 19.3 | 57.8 | 3.0 | 20.0 | 19.6 | 57.3 | 3.0 | 19.8 | 25.5 | 636.1 | 71 |
| example 12-3 | | | | | | | | | | | |
| Comparative | 37.7 | 39.3 | 3.0 | 20.0 | 38.0 | 38.9 | 3.0 | 19.8 | 49.4 | 442.9 | 94 |
| example 12-4 | | | | | | | | | | | |
| Comparative | 38.5 | 38.5 | 3.0 | 20.0 | 38.8 | 38.2 | 3.0 | 19.8 | 50.4 | 413.8 | 94 |
| example 12-5 | | | | | | | | | | | |

As Comparative examples 12-1 to 12-5 relative to Examples 12-1 to 12-8, anode active materials were synthesized in the same manner as in Examples 12-1 to 12-8, except that the Fe/(Sn+Fe) ratio was changed as shown in Table 11. The Fe/(Sn+Fe) ratios in Comparative examples 12-1 to 12-5 were 19 wt %, 21 wt %, 25 wt %, 49 wt %, and 50 wt %, respectively.

For the anode active materials of Examples 12-1 to 12-8 and Comparative examples 12-1 to 12-5, composition analysis was performed in the same manner as in Examples 1-1 to 1-10. The results are shown in Table 3. When XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element.

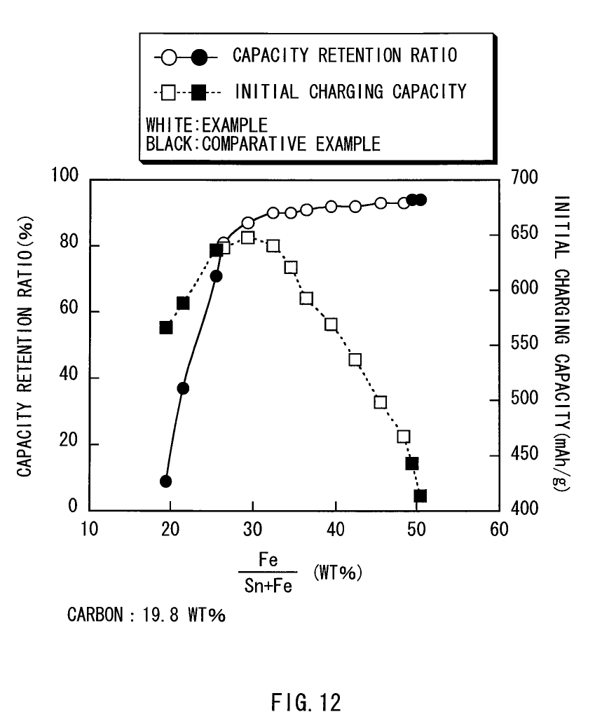

Next, secondary batteries were fabricated by using the anode active material powders of Examples 12-1 to 12-8 and Comparative examples 12-1 to 12-5 in the same manner as in Examples 1-1 to 1-10, and the initial charging capacity and the cycle characteristics were similarly measured. The results are shown in Table 11 and FIG. 12.

As evidenced by Table 11 and FIG. 12, according to Examples 10-5 and 12-1 to 12-8, in which the Fe/(Sn+Fe) ratio of the synthesized anode active material was from 26.4 wt % to 48.4 wt %, both the capacity retention ratio and the initial charging capacity could be improved than in Comparative examples 12-1 to 12-5 in which the Fe/(Sn+Fe) ratio was out of the foregoing range. In particular, in Examples 10-5 and 12-2 to 12-7, in which the Fe/(Sn+Fe) ratio was from 29.4 wt % to 45.5 wt %, higher values were obtained.

That is, it was found that as long as the Fe/(Sn+Fe) ratio in the anode active material was from 26.4 wt % to 8.4 wt %, more preferably from 29.4 wt % to 45.5 wt %, the capacity and the cycle characteristics could be improved even when the carbon content was 19.8 wt %.

### Examples 13-1 to 13-8

Anode active materials were synthesized in the same manner as in Examples 10-1 to 10-10, except that the raw material ratio among tin, iron, silver, and carbon was changed as shown in Table 12. Specifically, the raw material ratio of silver was constantly maintained at 3.0 wt %, the raw material ratio of carbon was constantly maintained at 12.0 wt %, and the Fe/(Sn+Fe) ratio was changed in the range from 26 wt % to 48 wt %.

TABLE 12

| | | | | | | | | | | Initial | |
|---|---|---|---|---|---|---|---|---|---|---|---|
| | Raw material ratio | | | | Analytical value | | | | | charging | Capacity |
| | (wt %) | | | | (wt %) | | | | | capacity | retention |
| | Fe | Sn | Ag | C | Fe | Sn | Ag | C | Fe/(Sn + Fe) | (mAh/g) | ratio (%) |
| Example 13-1 | 22.1 | 62.9 | 3.0 | 12.0 | 22.4 | 62.4 | 3.0 | 11.9 | 26.4 | 551.6 | 58 |
| Example 13-2 | 24.7 | 60.4 | 3.0 | 12.0 | 25.0 | 59.9 | 3.0 | 11.9 | 29.5 | 559.6 | 64 |
| Example 10-1 | 27.2 | 57.8 | 3.0 | 12.0 | 27.5 | 57.4 | 3.0 | 11.9 | 32.7 | 553.3 | 65 |
| Example 13-3 | 28.9 | 56.1 | 3.0 | 12.0 | 29.2 | 55.6 | 3.0 | 11.9 | 34.4 | 536.4 | 66 |
| Example 13-4 | 30.6 | 54.4 | 3.0 | 12.0 | 30.9 | 54.0 | 3.0 | 11.9 | 36.4 | 511.9 | 68 |
| Example 13-5 | 33.2 | 51.9 | 3.0 | 12.0 | 33.5 | 51.5 | 3.0 | 11.9 | 39.4 | 491.8 | 70 |
| Example 13-6 | 35.7 | 49.3 | 3.0 | 12.0 | 36.0 | 48.9 | 3.0 | 11.9 | 42.4 | 464.2 | 71 |
| Example 13-7 | 38.3 | 46.8 | 3.0 | 12.0 | 38.6 | 46.4 | 3.0 | 11.9 | 45.4 | 430.8 | 72 |
| Example 13-8 | 40.8 | 44.2 | 3.0 | 12.0 | 41.1 | 43.8 | 3.0 | 11.9 | 48.4 | 403.9 | 75 |
| Comparative | 16.2 | 68.9 | 3.0 | 12.0 | 16.5 | 68.3 | 3.0 | 11.9 | 19.5 | 489.0 | 7 |
| example 13-1 | | | | | | | | | | | |
| Comparative | 17.9 | 67.2 | 3.0 | 12.0 | 18.2 | 66.6 | 3.0 | 11.9 | 21.5 | 508.0 | 11 |
| example 13-2 | | | | | | | | | | | |
| Comparative | 21.3 | 63.8 | 3.0 | 12.0 | 21.6 | 63.3 | 3.0 | 11.9 | 25.4 | 549.6 | 45 |
| example 13-3 | | | | | | | | | | | |
| Comparative | 41.7 | 43.4 | 3.0 | 12.0 | 42.0 | 43.0 | 3.0 | 11.9 | 49.4 | 382.7 | 76 |
| example 13-4 | | | | | | | | | | | |
| Comparative | 42.5 | 42.5 | 3.0 | 12.0 | 42.8 | 42.2 | 3.0 | 11.9 | 50.4 | 357.5 | 77 |
| example 13-5 | | | | | | | | | | | |

As Comparative examples 13-1 to 13-5 relative to Examples 13-1 to 13-8, anode active materials were synthesized in the same manner as in Examples 13-1 to 13-8, except that the Fe/(Sn+Fe) ratio was changed as shown in Table 12. The Fe/(Sn+Fe) ratios in Comparative examples 13-1 to 13-5 were 19 wt %, 21 wt %, 25 wt %, 59 wt %, or 50 wt %, respectively.

For the anode active materials of Examples 13-1 to 13-8 and Comparative examples 13-1 to 13-5, composition analysis was performed in the same manner as in Examples 1-1 to 1-10. The results are shown in Table 12. When XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element.

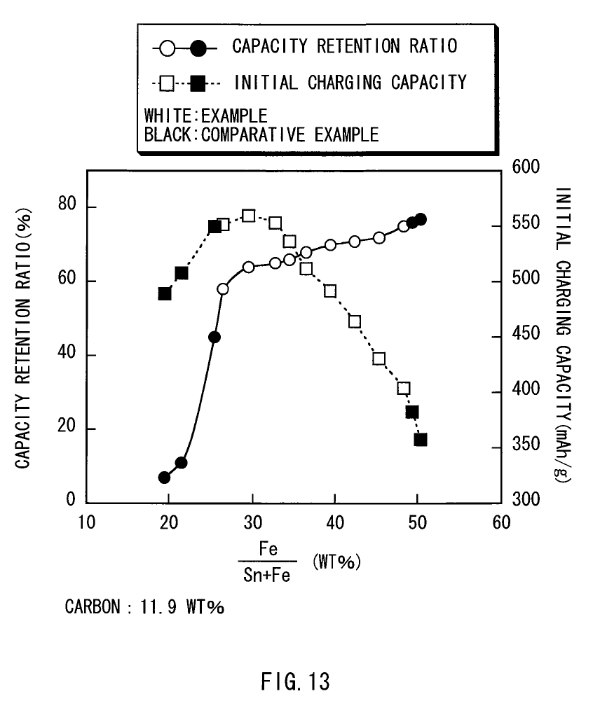

Next, secondary batteries were fabricated by using the anode active material powders of Examples 13-1 to 13-8 and Comparative examples 13-1 to 13-5 in the same manner as in Examples 1-1 to 1-10, and the initial charging capacity and the cycle characteristics were similarly measured. The results are shown in Table 12 and FIG. 13.

As evidenced by Table 12 and FIG. 13, according to Examples 10-1 and 13-1 to 13-8, in which the Fe/(Sn+Fe) ratio of the synthesized anode active material was from 26.4 wt % to 48.4 wt %, both the capacity retention ratio and the initial charging capacity could be improved than in Comparative examples 13-1 to 13-5 in which the Fe/(Sn+Fe) ratio was out of the foregoing range. In particular, in Examples 10-1 and 13-2 to 13-7, in which the Fe/(Sn+Fe) ratio was in the range from 29.5 wt % to 45.4 wt %, higher values were obtained.

That is, it was found that as long as the Fe/(Sn+Fe) ratio in the anode active material was from 26.4 wt % to 48.4 wt %, more preferably from 29.5 wt % to 45.4 wt %, the capacity and the cycle characteristics could be improved even when the carbon content was 11.9 wt %.

### Examples 14-1 to 14-9

Anode active materials were synthesized in the same manner as in Examples 10-1 to 10-10, except that the raw material ratio among tin, iron, silver, and carbon was changed as shown in Table 13. Specifically, the raw material ratio of silver was changed in the range from 0.1 wt % to 15.0 wt %, and the Fe/(Sn+Fe) ratio was 32.0 wt %.

TABLE 13

| | | | | | | | | | Initial | |
|---|---|---|---|---|---|---|---|---|---|---|
| | Raw material ratio | | | | Analytical value | | | | charging | Capacity |
| | (wt %) | | | | (wt %) | | | | capacity | retention |
| | Fe | Sn | Ag | C | Fe | Sn | Ag | C | (mAh/g) | ratio (%) |
| Example 1-5 | 25.6 | 54.4 | 0 | 20.0 | 25.8 | 54.0 | 0 | 19.8 | 644.2 | 85 |
| Example 14-1 | 25.6 | 54.3 | 0.1 | 20.0 | 25.9 | 53.9 | 0.1 | 19.8 | 644.0 | 87 |
| Example 14-2 | 25.4 | 54.1 | 0.5 | 20.0 | 25.7 | 53.7 | 0.5 | 19.8 | 643.2 | 88 |
| Example 14-3 | 25.3 | 53.7 | 1.0 | 20.0 | 25.6 | 53.3 | 1.0 | 19.8 | 642.7 | 89 |
| Example 14-4 | 25.0 | 53.0 | 2.0 | 20.0 | 25.3 | 52.6 | 2.0 | 19.8 | 641.5 | 90 |
| Example 10-5 | 24.6 | 52.4 | 3.0 | 20.0 | 24.9 | 52.0 | 3.0 | 19.8 | 640.3 | 90 |
| Example 14-5 | 24.0 | 51.0 | 5.0 | 20.0 | 24.3 | 50.6 | 5.0 | 19.8 | 638.4 | 91 |
| Example 14-6 | 23.2 | 49.3 | 7.5 | 20.0 | 23.5 | 49.0 | 7.4 | 19.8 | 634.6 | 91 |
| Example 14-7 | 22.4 | 47.6 | 10.0 | 20.0 | 22.7 | 47.3 | 9.9 | 19.8 | 630.1 | 92 |
| Example 14-8 | 21.8 | 46.2 | 12.0 | 20.0 | 22.1 | 45.9 | 11.9 | 19.8 | 623.4 | 92 |
| Example 14-9 | 20.8 | 44.2 | 15.0 | 20.0 | 21.0 | 43.9 | 14.8 | 19.8 | 615.3 | 92 |

For the anode active materials of Examples 14-1 to 14-9, the composition was analyzed in the same manner as in Examples 1-1 to 1-10. The results are shown in Table 13. Further, when XPS was performed, Peak P1 was obtained. When the obtained peak was analyzed, Peak P2 of surface contamination carbon and Peak P3 of C1s in the anode active material were obtained similarly to in Examples 1-1 to 1-10. For all cases, Peak P3 was obtained in the region lower than 284.5 eV. That is, it was confirmed that at least part of carbon contained in the anode active material was bonded to other element.

Next, secondary batteries were fabricated by using the anode active material powders of Examples 14-1 to 14-9 in the same manner as in Examples 1-1 to 1-10, and the initial charging capacity and the cycle characteristics were similarly measured. The results are shown in Table 13 together with the results of Examples 1-5 and 10-5.

As evidenced by Table 13, according to Examples 10-5 and 14-1 to 14-9 containing silver, the capacity retention ratio could be improved than in Example 1-5 not containing silver. However, there was a tendency that as the silver content became large, the initial charging capacity was lowered.

That is, it was found that when silver was contained in the anode active material, cycle characteristics could be improved, and the silver content was preferably in the range from 0.1 wt % to 9.9 wt %, more preferably in the range from 1.0 wt % to 7.4 wt %, and in particular desirably in the range from 2.0 wt % to 5.0 wt %.

### Examples 15-1 to 15-14

Anode active materials were synthesized in the same manner as in Examples 10-5, except that silicon powder was further used as a raw material, and the raw material ratio among tin, iron, silver, carbon, and silicon was changed as shown in Table 14. Specifically, the raw material ratio of silicon powder was changed in the range from 0.2 wt % to 10.0 wt %, and the Fe/(Sn+Fe) ratio was 32.0 wt %. For the anode active material of Examples 15-1 to 15-14, the composition was analyzed in the same manner as in Examples 1-1 to 1-10. The results are shown in Table 14. Further, when XPS was performed, Peak P1 was obtained. When the obtained peak was analyzed, Peak P2 of surface contamination carbon and Peak P3 of Cis in the anode active material were obtained similarly to in Examples 1-1 to 1-10. For all cases, Peak P3 was obtained in the region lower than 284.5 eV. That is, it was confirmed that at least part of carbon contained in the anode active material was bonded to other element.

TABLE 14

| | | | | | | | | | | | Initial | |
|---|---|---|---|---|---|---|---|---|---|---|---|---|
| | Raw material ratio | | | | | Analytical value | | | | | charging | Capacity |
| | (wt %) | | | | | (wt %) | | | | | capacity | retention |
| | Fe | Sn | Ag | C | Si | Fe | Sn | Ag | C | Si | (mAh/g) | ratio (%) |
| Example 10-5 | 24.6 | 52.4 | 3.0 | 20.0 | 0 | 24.9 | 52.0 | 3.0 | 19.8 | 0 | 640.3 | 90 |
| Example 15-1 | 24.6 | 52.2 | 3.0 | 20.0 | 0.2 | 24.8 | 51.8 | 3.0 | 19.8 | 0.2 | 641.0 | 90 |
| Example 15-2 | 24.5 | 52.1 | 3.0 | 20.0 | 0.4 | 24.7 | 51.6 | 3.0 | 19.8 | 0.4 | 641.4 | 90 |
| Example 15-3 | 24.5 | 52.0 | 3.0 | 20.0 | 0.5 | 24.7 | 51.5 | 3.0 | 19.8 | 0.5 | 644.7 | 89 |
| Example 15-4 | 24.4 | 51.8 | 3.0 | 20.0 | 0.8 | 24.6 | 51.3 | 3.0 | 19.8 | 0.8 | 652.8 | 89 |
| Example 15-5 | 24.3 | 51.7 | 3.0 | 20.0 | 1.0 | 24.5 | 51.2 | 3.0 | 19.8 | 1.0 | 658.3 | 88 |
| Example 15-6 | 24.0 | 51.0 | 3.0 | 20.0 | 2.0 | 24.2 | 50.5 | 3.0 | 19.8 | 2.0 | 675.9 | 87 |
| Example 15-7 | 23.7 | 50.3 | 3.0 | 20.0 | 3.0 | 23.9 | 49.8 | 3.0 | 19.8 | 3.0 | 687.9 | 85 |
| Example 15-8 | 23.4 | 49.6 | 3.0 | 20.0 | 4.0 | 23.6 | 49.2 | 3.0 | 19.8 | 4.0 | 696.4 | 82 |
| Example 15-9 | 23.0 | 49.0 | 3.0 | 20.0 | 5.0 | 23.2 | 48.6 | 3.0 | 19.8 | 4.9 | 706.0 | 80 |
| Example 15-10 | 22.7 | 48.3 | 3.0 | 20.0 | 6.0 | 23.0 | 47.9 | 3.0 | 19.8 | 5.9 | 712.2 | 77 |
| Example 15-11 | 22.4 | 47.6 | 3.0 | 20.0 | 7.0 | 22.6 | 47.2 | 3.0 | 19.8 | 6.9 | 717.0 | 74 |
| Example 15-12 | 22.1 | 46.9 | 3.0 | 20.0 | 8.0 | 22.3 | 46.5 | 3.0 | 19.8 | 7.9 | 720.7 | 69 |
| Example 15-13 | 21.8 | 46.2 | 3.0 | 20.0 | 9.0 | 22.0 | 45.8 | 3.0 | 19.8 | 8.9 | 725.3 | 55 |
| Example 15-14 | 21.4 | 45.6 | 3.0 | 20.0 | 10.0 | 21.6 | 45.2 | 3.0 | 19.8 | 9.8 | 727.8 | 23 |

As evidenced by Table 14, according to Examples 15-1 to 15-14 containing silicon, the initial charging capacity could be improved than in Example 10-5 not containing silicon. However, there was a tendency that as the silicon content became large, the capacity retention ratio was lowered.

That is, it was found that when silicon was contained in the anode active material, a capacity could be improved, and the silicon content was preferably in the range from 0.5 wt % to 7.9 wt %.

### Examples 16-1 to 16-18

In Examples 6-1 to 6-16, anode active materials were synthesized in the same manner as in Example 10-5, except that for the raw material, at least one from the group consisting of aluminum powder, titanium powder, vanadium powder, chromium powder, niobium powder, and tantalum powder was used as a first element, at least one from the group consisting of cobalt powder, nickel powder, copper powder, zinc powder, gallium powder, and indium powder was used as a second element, and the raw material ratio among tin, iron, silver, carbon, the first element, and the second element was set as shown in Table 15. Further, in Example 16-17, an anode active material was synthesized in the same manner as in Example 10-5, except that for the raw material, titanium powder was prepared as a first element, and the raw material ratio among tin, iron, silver, carbon, and titanium was set as shown in Table 15. Further, in Example 6-18, an anode active material was synthesized in the same manner as in Example 10-5, except that for the raw material, zinc powder was prepared as a second element, and the raw material ratio among tin, iron, silver, carbon, and zinc was set as shown in Table 15. For the anode active materials, composition analysis was performed in the same manner as in Examples 1-1 to 1-10. The results are shown in Table 15. Further, when XPS was performed, Peak P1 was obtained. When the obtained peak was analyzed, Peak P2 of surface contamination carbon and Peak P3 of C1s in the anode active material were obtained similarly to in Examples 1-1 to 1-10. Peak P3 was obtained in the region lower than 284.5 eV in all cases. That is, it was confirmed that at least part of carbon contained in the anode active material was bonded to other element.

TABLE 15

| | | | | | | | | | | | | | | | | | Initial | Capac- |
|---|---|---|---|---|---|---|---|---|---|---|---|---|---|---|---|---|---|---|
| | Raw material ratio | | | | | | | | Analytical value | | | | | | | | charg- | ity |
| | (wt %) | | | | | | | | (wt %) | | | | | | | | ing | re- |
| | | | | | 1st | | 2nd | | | | | | 1st | | 2nd | | capacity | tention |
| | Fe | Sn | Ag | C | element | | element | | Fe | Sn | Ag | C | element | | element | | (mAh/ | ratio |
| | wt % | wt % | wt % | wt % | Kind | wt % | Kind | wt % | wt % | wt % | wt % | wt % | Kind | wt % | Kind | wt % | g) | (%) |
| Example 10-5 | 24.6 | 52.4 | 3.0 | 20.0 | — | — | — | — | 24.9 | 52.0 | 3.0 | 19.8 | — | — | — | — | 640.3 | 90 |
| Example 16-1 | 22.8 | 48.6 | 3.0 | 18.6 | Al | 2.0 | Zn | 5.0 | 23.0 | 48.1 | 3.0 | 18.4 | Al | 2.0 | Zn | 5.0 | 634.3 | 94 |
| Example 16-2 | 22.6 | 48.0 | 3.0 | 18.4 | Ti | 3.0 | Zn | 5.0 | 22.8 | 47.5 | 3.0 | 18.2 | Ti | 3.0 | Zn | 5.0 | 633.9 | 95 |
| Example 16-3 | 22.8 | 48.6 | 3.0 | 18.6 | V | 2.0 | Zn | 5.0 | 23.0 | 48.1 | 3.0 | 18.4 | V | 2.0 | Zn | 5.0 | 634.7 | 93 |
| Example 16-4 | 22.6 | 48.0 | 3.0 | 18.4 | Cr | 3.0 | Zn | 5.0 | 22.8 | 47.5 | 3.0 | 18.2 | Cr | 3.0 | Zn | 5.0 | 633.0 | 93 |
| Example 16-5 | 22.6 | 48.0 | 3.0 | 18.4 | Nb | 3.0 | Zn | 5.0 | 22.8 | 47.5 | 3.0 | 18.2 | Nb | 3.0 | Zn | 5.0 | 632.7 | 92 |
| Example 16-6 | 22.8 | 48.6 | 3.0 | 18.6 | Ta | 2.0 | Zn | 5.0 | 23.0 | 48.1 | 3.0 | 18.4 | Ta | 2.0 | Zn | 5.0 | 634.2 | 93 |
| Example 16-7 | 20.8 | 44.1 | 3.0 | 17.0 | Al | 0.1 | Co | 15.0 | 21.0 | 43.7 | 3.0 | 16.8 | Al | 0.1 | Co | 14.9 | 626.0 | 95 |
| Example 16-8 | 22.0 | 46.6 | 3.0 | 17.9 | Al | 10.0 | Ni | 0.5 | 22.2 | 46.1 | 3.0 | 17.7 | Al | 9.9 | Ni | 0.5 | 627.8 | 94 |
| Example 16-9 | 23.1 | 49.0 | 3.0 | 18.8 | Ti | 0.1 | Cu | 6.0 | 23.3 | 48.5 | 3.0 | 18.6 | Ti | 0.1 | Cu | 6.0 | 636.5 | 92 |
| Example | 21.3 | 45.3 | 3.0 | 17.4 | Ti | 10.0 | Ga | 3.0 | 21.5 | 44.8 | 3.0 | 17.2 | Ti | 9.9 | Ga | 3.0 | 626.7 | 93 |
| 16-10 | | | | | | | | | | | | | | | | | | |
| Example | 24.5 | 52.0 | 3.0 | 19.9 | Cr | 0.1 | In | 0.5 | 24.7 | 51.5 | 3.0 | 19.7 | Cr | 0.1 | In | 0.5 | 639.9 | 92 |
| 16-11 | | | | | | | | | | | | | | | | | | |
| Example | 22.0 | 46.6 | 3.0 | 17.9 | Cr | 10.0 | In | 0.5 | 22.2 | 46.1 | 3.0 | 17.7 | Cr | 9.9 | In | 0.5 | 628.2 | 93 |
| 16-12 | | | | | | | | | | | | | | | | | | |
| Example | 23.3 | 49.6 | 3.0 | 19.0 | Nb | 0.1 | Cu | 4.0 | 23.5 | 49.1 | 3.0 | 18.8 | Nb | 0.1 | Cu | 4.0 | 637.1 | 93 |
| 16-13 | | | | | Ta | 0.5 | Zn | 0.5 | | | | | Ta | 0.5 | Zn | 0.5 | | |
| Example | 22.0 | 46.6 | 3.0 | 17.9 | Nb | 10.0 | Co | 0.5 | 22.2 | 46.3 | 3.0 | 17.7 | Nb | 9.9 | Co | 0.5 | 628.4 | 94 |
| 16-14 | | | | | | | | | | | | | | | | | | |
| Example | 19.8 | 42.0 | 3.0 | 16.2 | Cr | 3.0 | Zn | 16.0 | 20.0 | 41.7 | 3.0 | 16.0 | Cr | 3.0 | Zn | 15.9 | 604.6 | 95 |
| 16-15 | | | | | | | | | | | | | | | | | | |
| Example | 17.5 | 37.1 | 3.0 | 14.4 | Al | 12.0 | Cu | 16.0 | 17.7 | 36.9 | 3.0 | 14.3 | Al | 11.9 | Cu | 15.9 | 558.7 | 96 |
| 16-16 | | | | | | | | | | | | | | | | | | |
| Example | 23.6 | 50.2 | 3.0 | 19.2 | Ti | 4.0 | — | — | 23.8 | 49.7 | 3.0 | 19.0 | Ti | 4.0 | — | — | 637.5 | 90 |
| 16-17 | | | | | | | | | | | | | | | | | | |
| Example | 23.4 | 49.6 | 3.0 | 19.0 | — | — | Zn | 5.0 | 23.6 | 49.1 | 3.0 | 18.8 | — | — | Zn | 5.0 | 636.9 | 90 |
| 16-18 | | | | | | | | | | | | | | | | | | |

Next, secondary batteries were fabricated by using the anode active material powder of Examples 16-1 to 16-18 in the same manner as in Examples 1-1 to 1-10, and the initial charging capacity and the cycle characteristics were similarly measured. The results are shown in Table 15.

As evidenced by Table 15, according to Examples 16-1 to 16-16 containing the first element and the second element, the capacity retention ratio could be improved than in Example 10-5 not containing the first element and the second element, Example 16-17 containing only the first element, or Example 16-18 containing only the second element.

Further, according to Examples 16-1 to 16-14, in which the first element content was from 0.1 wt % to 9.9 wt % and the second element content was from 0.5 wt % to 14.9 wt %, high values could be obtained for the initial charging capacity as well.

That is, it was found that when at least one from the group consisting of aluminum, titanium, vanadium, chromium, niobium, and tantalum, and at least one from the group consisting of cobalt, nickel, copper, zinc, gallium, and indium were contained in the anode active material, cycle characteristics could be improved, even if silver was contained and it was found that when the contents thereof were from 0.1 wt % to 9.9 wt % and from 0.5 wt % to 14.9 wt %, respectively, a high capacity could be obtained.

### Examples 17-1 to 17-19

Secondary batteries were fabricated in the same manner as in Example 10-5, except that two or more of 4-fluoro-1,3-dioxolane-2-one as a cyclic carbonate having halogen atom, ethylene carbonate, propylene carbonate, and dimethyl carbonate were used as a solvent, and the 4-fluoro-1,3-dioxolane-2-one content was changed in the range from 0 wt % to 80.0 wt %. Specific composition of each solvent was as shown in Table 16.

TABLE 16

| | Raw material ratio | | | | Analytical value | | | | Solvent | | | | Capacity |
|---|---|---|---|---|---|---|---|---|---|---|---|---|---|
| | (wt %) | | | | (wt %) | | | | (wt %) | | | | retention |
| | Fe | Sn | Ag | C | Fe | Sn | Ag | C | FEC | EC | PC | DMC | ratio (%) |
| Example 17-1 | 24.6 | 52.4 | 3.0 | 20.0 | 24.9 | 52.0 | 3.0 | 19.8 | 0 | 30.0 | 10.0 | 60.0 | 82 |
| Example 17-2 | 24.6 | 52.4 | 3.0 | 20.0 | 24.9 | 52.0 | 3.0 | 19.8 | 0.1 | 29.9 | 10.0 | 60.0 | 83 |
| Example 17-3 | 24.6 | 52.4 | 3.0 | 20.0 | 24.9 | 52.0 | 3.0 | 19.8 | 0.5 | 29.5 | 10.0 | 60.0 | 85 |
| Example 17-4 | 24.6 | 52.4 | 3.0 | 20.0 | 24.9 | 52.0 | 3.0 | 19.8 | 1.0 | 29.0 | 10.0 | 60.0 | 87 |
| Example 17-5 | 24.6 | 52.4 | 3.0 | 20.0 | 24.9 | 52.0 | 3.0 | 19.8 | 5.0 | 25.0 | 10.0 | 60.0 | 89 |
| Example 17-6 | 24.6 | 52.4 | 3.0 | 20.0 | 24.9 | 52.0 | 3.0 | 19.8 | 10.0 | 20.0 | 10.0 | 60.0 | 90 |
| Example 17-7 | 24.6 | 52.4 | 3.0 | 20.0 | 24.9 | 52.0 | 3.0 | 19.8 | 15.0 | 15.0 | 10.0 | 60.0 | 90 |
| Example 17-8 | 24.6 | 52.4 | 3.0 | 20.0 | 24.9 | 52.0 | 3.0 | 19.8 | 20.0 | 10.0 | 10.0 | 60.0 | 91 |
| Example 17-9 | 24.6 | 52.4 | 3.0 | 20.0 | 24.9 | 52.0 | 3.0 | 19.8 | 20.0 | 20.0 | 0 | 60.0 | 91 |
| Example 17-10 | 24.6 | 52.4 | 3.0 | 20.0 | 24.9 | 52.0 | 3.0 | 19.8 | 25.0 | 5.0 | 10.0 | 60.0 | 92 |
| Example 17-11 | 24.6 | 52.4 | 3.0 | 20.0 | 24.9 | 52.0 | 3.0 | 19.8 | 30.0 | 0 | 10.0 | 60.0 | 92 |
| Example 17-12 | 24.6 | 52.4 | 3.0 | 20.0 | 24.9 | 52.0 | 3.0 | 19.8 | 30.0 | 10.0 | 0 | 60.0 | 93 |
| Example 17-13 | 24.6 | 52.4 | 3.0 | 20.0 | 24.9 | 52.0 | 3.0 | 19.8 | 35.0 | 0 | 5.0 | 60.0 | 93 |
| Example 17-14 | 24.6 | 52.4 | 3.0 | 20.0 | 24.9 | 52.0 | 3.0 | 19.8 | 40.0 | 0 | 0 | 60.0 | 94 |
| Example 17-15 | 24.6 | 52.4 | 3.0 | 20.0 | 24.9 | 52.0 | 3.0 | 19.8 | 50.0 | 0 | 0 | 50.0 | 93 |
| Example 17-16 | 24.6 | 52.4 | 3.0 | 20.0 | 24.9 | 52.0 | 3.0 | 19.8 | 60.0 | 0 | 0 | 40.0 | 91 |
| Example 17-17 | 24.6 | 52.4 | 3.0 | 20.0 | 24.9 | 52.0 | 3.0 | 19.8 | 65.0 | 0 | 0 | 35.0 | 88 |
| Example 17-18 | 24.6 | 52.4 | 3.0 | 20.0 | 24.9 | 52.0 | 3.0 | 19.8 | 70.0 | 0 | 0 | 30.0 | 87 |
| Example 17-19 | 24.6 | 52.4 | 3.0 | 20.0 | 24.9 | 52.0 | 3.0 | 19.8 | 80.0 | 0 | 0 | 20.0 | 85 |

EC: Ethylene carbonate
PC: Propylene carbonate
DMC: Dimethyl carbonate
FEC: 4-fluoro-1,3-dioxolane-2-one

For the secondary batteries of Examples 17-1 to 17-19, the cycle characteristics were examined in the same manner as in Examples 1-1 to 1-10. The results are shown in Table 16.

As evidenced by Table 16, as the 4-fluoro-1,3-dioxolane-2-one content was improved, the capacity retention ratio became large, showed the maximum value, and then decreased.

That is, it was found that when the cyclic carbonate derivative having halogen atom was contained, cycle characteristics could be improved.

### Examples 18-1 to 18-8, 19-1

In Examples 18-1 to 18-8, secondary batteries were fabricated in the same manner as in Example 10-5, except that 1,3,2-dioxathiolane-2-oxide as a cyclic sulfur compound, 4-fluoro-1,3-dioxolane-2-one as a cyclic carbonate having halogen atom, ethylene carbonate, propylene carbonate, and dimethyl carbonate were used as a solvent, and the 1,3,2-dioxathiolane-2-oxide content in the solvent was changed in the range from 0.1 wt % to 10.0 wt %. Specific composition of each solvent was as shown in Table 17.

Further, in Example 19-1, a secondary battery was fabricated in the same manner as in Example 10-5, except that 1,3,2-dioxathiolane-2-oxide as a cyclic sulfur compound, ethylene carbonate, propylene carbonate, and dimethyl carbonate were used as a solvent. The 1,3,2-dioxathiolane-2-oxide content in the solvent was 3.0 wt %, and the contents of other solvents were as shown in Table 17.

For the secondary batteries of Examples 18-1 to 18-8 and 19-1, the cycle characteristics were examined in the same manner as in Examples 1-1 to 1-10. The results are shown in Table 17 together with the results of Examples 17-1 and 17-6.

TABLE 17

| | Raw material ratio | | | | Analytical value | | | | Solvent | | | | | Capacity |
|---|---|---|---|---|---|---|---|---|---|---|---|---|---|---|
| | (wt %) | | | | (wt %) | | | | (wt %) | | | | | retention |
| | Fe | Sn | Ag | C | Fe | Sn | Ag | C | ES | FEC | EC | PC | DMC | ratio (%) |
| Example 17-6 | 24.6 | 52.4 | 3.0 | 20.0 | 24.9 | 52.0 | 3.0 | 19.8 | 0 | 10.0 | 20.0 | 10.0 | 60.0 | 90 |
| Example 18-1 | 24.6 | 52.4 | 3.0 | 20.0 | 24.9 | 52.0 | 3.0 | 19.8 | 0.1 | 10.0 | 20.0 | 10.0 | 59.9 | 91 |
| Example 18-2 | 24.6 | 52.4 | 3.0 | 20.0 | 24.9 | 52.0 | 3.0 | 19.8 | 0.5 | 10.0 | 20.0 | 10.0 | 59.5 | 92 |
| Example 18-3 | 24.6 | 52.4 | 3.0 | 20.0 | 24.9 | 52.0 | 3.0 | 19.8 | 1.0 | 10.0 | 20.0 | 10.0 | 59.0 | 93 |
| Example 18-4 | 24.6 | 52.4 | 3.0 | 20.0 | 24.9 | 52.0 | 3.0 | 19.8 | 2.0 | 10.0 | 20.0 | 10.0 | 58.0 | 94 |
| Example 18-5 | 24.6 | 52.4 | 3.0 | 20.0 | 24.9 | 52.0 | 3.0 | 19.8 | 3.0 | 10.0 | 20.0 | 10.0 | 57.0 | 95 |
| Example 18-6 | 24.6 | 52.4 | 3.0 | 20.0 | 24.9 | 52.0 | 3.0 | 19.8 | 5.0 | 10.0 | 20.0 | 10.0 | 55.0 | 95 |
| Example 18-7 | 24.6 | 52.4 | 3.0 | 20.0 | 24.9 | 52.0 | 3.0 | 19.8 | 7.5 | 10.0 | 20.0 | 10.0 | 52.5 | 92 |
| Example 18-8 | 24.6 | 52.4 | 3.0 | 20.0 | 24.9 | 52.0 | 3.0 | 19.8 | 10.0 | 10.0 | 20.0 | 10.0 | 40.0 | 91 |
| Example 17-1 | 24.6 | 52.4 | 3.0 | 20.0 | 24.9 | 52.0 | 3.0 | 19.8 | 0 | 0 | 30.0 | 10.0 | 60.0 | 82 |
| Example 19-1 | 24.6 | 52.4 | 3.0 | 20.0 | 24.9 | 52.0 | 3.0 | 19.8 | 3.0 | 0 | 27.0 | 10.0 | 60.0 | 82 |

EC: Ethylene carbonate
PC: Propylene carbonate
DMC: Dimethyl carbonate
FEC: 4-fluoro-1,3-dioxolane-2-one
ES: 1,3,2-dioxathiolane-2-oxide

As evidenced by Table 17, in Examples 17-6 and 18-1 to 18-8 using 4-fluoro-1,3-dioxolane-2-one, as the 1,3,2-dioxathiolane-2-oxide content was increased, the capacity retention ratio became large, showed the maximum value, and then decreased. Meanwhile, in Examples 17-1 and 19-1 not using 4-fluoro-1,3-dioxolane-2-one, effect of improving the capacity retention ratio by using 1,3,2-dioxathiolane-2-oxide was not shown.

That is, it was found that when the cyclic sulfur compound was contained in the electrolytic solution in addition to the cyclic carbonate derivative having halogen atom, cycle characteristics could be more improved, and it was found that the cyclic sulfur compound content in the solvent was preferably from 0.1 wt % to 10 wt %.

The present invention has been described with reference to the embodiment and the examples. However, the present invention is not limited to the embodiment and the examples, and various modifications may be made. For example, in the foregoing embodiment and examples, descriptions have been given with reference to the coin type secondary battery and the secondary battery having the spirally wound structure. However, the present invention can be similarly applied to a secondary battery having other shape such as a button type secondary battery, a sheet type secondary battery, and a square type secondary battery, or a secondary battery having other laminated structure, in which a plurality of cathodes and a plurality of anodes are layered.

Further, in the embodiment and the examples, descriptions have been given of the case using lithium as an electrode reactant. However, as long as reactive to the anode active material, when other element of Group 1 in the long period periodic table such as sodium (Na) and potassium (K), an element of Group 2 in the long period periodic table such as magnesium (Mg) and calcium (Ca), other light metal such as aluminum, or an alloy of lithium or the foregoing element is used, the present invention can be applied as well, and similar effects can be obtained. Then, a cathode active material capable of inserting and extracting an electrode reactant, a nonaqueous solvent and the like are selected according to the electrode reactant.

In the foregoing embodiment and the foregoing examples, descriptions have been given of the case using the electrolytic solution as an electrolyte. Further, in the foregoing embodiment, descriptions have been given of the case using the gelatinous electrolyte in which an electrolytic solution is held in a high molecular weight compound. However, other electrolyte may be used. As other electrolyte, for example, an ion conductive inorganic compound such as ion conductive ceramics, ion conductive glass, and ionic crystal; other inorganic compound; or a mixture of the foregoing inorganic compound and an electrolytic solution or a gelatinous electrolyte can be cited.

It should be understood by those skilled in the art that various modifications, combinations, sub-combinations and alternations may occur depending on design requirements and other factors insofar as they are within the scope of the appended claims or the equivalents thereof.

What is claimed is:

1. An anode active material, wherein at least tin (Sn), iron (Fe), and carbon (C) are contained as an element, and
the carbon content is from 11.9 wt % to 29.7 wt %, and the iron ratio to the total of tin and iron is from 26.4 wt % to 48.5 wt %.

2. The anode active material according to claim 1, wherein silver (Ag) is further contained as an element.

3. The anode active material according to claim 2, wherein the silver content is from 0.1 wt % to 9.9 wt %.

4. The anode active material according to claim 1, wherein a first element composed of at least one from the group consisting of aluminum (Al), titanium (Ti), vanadium (V), chromium (Cr), niobium (Nb), and tantalum (Ta), and a second element composed of at least one from the group consisting of cobalt (Co), nickel (Ni), copper (Cu), zinc (Zn), gallium (Ga), and indium (In) are contained as an element.

5. The anode active material according to claim 4, wherein the first element content is from 0.1 wt % to 9.9 wt %.

6. The anode active material according to claim 4, wherein the second element content is from 0.5 wt % to 14.9 wt %.

7. The anode active material according to claim 1, wherein silicon (Si) is further contained as an element.

8. The anode active material according to claim 7, wherein the silicon content is from 0.5 wt % to 7.9 wt %.

9. A battery comprising:
a cathode;
an anode; and
an electrolyte,
wherein the anode contains an anode active material containing at least tin (Sn), iron (Fe), and carbon (C) as an element, and
the carbon content in the anode active material is from 11.9 wt % to 29.7 wt %, and the iron ratio to the total of tin and iron is from 26.4 wt % to 48.5 wt %.

10. The battery according to claim 9, wherein the anode active material further contains silver (Ag) as an element.

11. The battery according to claim 10, wherein the silver content in the anode active material is from 0.1 wt % to 9.9 wt %.

12. The battery according to claim 9, wherein the anode active material further contains a first element composed of at least one from the group consisting of aluminum (Al), titanium (Ti), vanadium (V), chromium (Cr), niobium (Nb), and tantalum (Ta), and a second element composed of at least one from the group consisting of cobalt (Co), nickel (Ni), copper (Cu), zinc (Zn), gallium (Ga), and indium (In).

13. The battery according to claim 12, wherein the first element content in the anode active material is from 0.1 wt % to 9.9 wt %.

14. The battery according to claim 12, wherein the second element content in the anode active material is from 0.5 wt % to 14.9 wt %.

15. The battery according to claim 9, wherein the anode active material further contains silicon (Si) as an element.

16. The battery according to claim 15, wherein the silicon content in the anode active material is from 0.5 wt % to 7.9 wt %.

17. The battery according to claim 9, wherein the electrolyte contains a solvent containing a cyclic carbonate derivative having halogen atom.

18. The battery according to claim 17, wherein the cyclic carbonate derivative content in the solvent is from 0.1 wt % to 80 wt %.

19. The battery according to claim 17, wherein the solvent further contains a cyclic sulfur compound.

20. The battery according to claim 19, wherein the cyclic sulfur compound content in the solvent is from 0.1 wt % to 10 wt %.

21. The battery according to claim 19, wherein the cyclic sulfur compound contains a compound shown in Chemical formula 1. 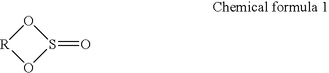
wherein R represents a group expressed by —(CH₂)ₙ—, or a group obtained by substituting at least part of hydrogen thereof with a substituent; and n is 2, 3, or 4.

22. The battery according to claim 19, wherein the cyclic sulfur compound contains at least one from the group consisting of 1,3,2-dioxathiolane-2-oxide shown in Chemical formula 2 and derivatives thereof. [chemical structure]
